(19) United States
(12) Patent Application Publication
(10) Pub. No.: US 2022/0019588 A1
(43) Pub. Date: Jan. 20, 2022

(54) METHODS AND SYSTEMS FOR CONSTRUCTING EXPRESSIONS THAT EXTRACTS METRICS FROM LOG MESSAGES

(71) Applicant: VMWARE, INC., Palo Alto, CA (US)

(72) Inventors: Chandrashekhar Jha, Bangalore (IN); Akash Srivastava, Bangalore (IN); Ritesh Jha, Bangalore (IN); Mithlesh Kumar, Bangalore (IN); Venkat Reddy Lingam, Bangalore (IN)

(21) Appl. No.: 17/008,755

(22) Filed: Sep. 1, 2020

(30) Foreign Application Priority Data
Jul. 14, 2020 (IN) 202041029930

(51) Int. Cl. G06F 16/2455; G06F 16/17

(52) U.S. Cl. CPC G06F 16/24553; G06F 16/1734

(57) ABSTRACT

Automated methods and systems for generating Grok expressions for extraction of metric data from any type of log message are described. Method and systems include construction of a directed graph from Grok patterns. A sample log message is selected from log messages that record metrics values of a desired metric. The directed graph is used to construct a Grok expression from the sample log message. The Grok expression is then used to parse log messages that are of the same type or format as the sample log message to extract the desired metric data from the log messages. The metric may in turn be used to troubleshoot problems anchor identifying potential root causes of problems in a data center or other type of distributed computing system.

### RELATED APPLICATIONS

Benefit is claimed tinder 35 U.S C. 119(a)-(d) to Foreign Application Serial No. 202041029930 filed in India entitled “METHODS AND SYSTEMS FOR CONSTRUCTING EXPRESSIONS THAT EXTRACTS METRICS FROM LOG MESSAGES”, on Jul. 14, 2020, by VMware, Inc., which is herein incorporated in its entirety by reference for all purposes.

### TECHNICAL FIELD

This disclosure is directed to automated methods and systems for constructing Grok expressions from log messages and use of the expressions for extracting metric data from log messages.

### BACKGROUND

Data centers execute thousands of applications that enable businesses, governments, and other organizations to offer services over the Internet. These organizations cannot afford problems that result in downtime or slow performance of their applications. Performance issues can frustrate users, damage a brand name, result in lost revenue, and deny people access to vital services. In order to aid system administrators and application owners with detection of problems, various management tools have been developed to collect performance information about applications, services, and hardware. A typical log management tool, for example, records log messages generated by various operating systems and applications executing in a data center. Each log message is an unstructured or semi-structured time-stamped message that records information about the state of an operating system, state of an application, state of a service, or state of computer hardware at a point in time. Most log messages record benign events, such as input/output operations, client requests, logouts, and statistical information about the execution of applications, operating systems, computer systems, and other devices of a data center. For example, a web server executing on a computer system generates a stream of log messages, each of which describes a date and time of a client request, web address requested by the client, and IP address of the client. Other log messages, on the other hand, record diagnostic information, such as alarms, warnings, errors, or emergencies. System administrators and application owners use log messages to perform root cause analysis of problems, perform troubleshooting, and monitor execution of applications, operating systems, computer systems, and other devices of the data center.

In recent years, log management tools have been developed to extract metrics embedded in log messages using parsing expressions. Metrics extracted from log messages may provide useful information that increases insights into troubleshooting and root cause analysis of problems. Extraction of metrics significantly decreases the amount of manual effort and errors that result from system administrators and application owners sifting through numerous log messages for useful metrics. However, because log messages are unstructured, system administrators and application owner's must manually construct it distinct parsing expression for each type of log message. Construction of parsing expressions involves a steep learning curve which is error prone, requires extensive debugging, and is time consuming. An imperfect parsing expression may miss extraction of a desired metric, resulting in incomplete information needed for troubleshooting and root cause analysis. System administrators and application owners seek methods and systems for accurately constructing parsing expressions that may be used to efficiently extract metrics from log messages.

### SUMMARY

Automated methods and systems described herein are directed to generating Grok expressions for extraction of metric data from any type of log message. Grok patterns are divided into primary and composite Grok patterns. Method and systems construct of a directed graph from the primary and composite Grok patterns. A sample log message is selected from log messages that record metrics values of a desired metric. The directed graph is used to construct a Grok expression from the sample log message. The Grok expression is then used to parse log messages that are of the same type or format as the sample log message to extract the desired metric data from the log messages. The metric may in turn be used to troubleshoot problems and/or identifying potential root causes of problems in a data center or other type of distributed computing system.

### DESCRIPTION OF THE DRAWINGS

FIG. 1 shows an example of logging log messages in log files.

FIG. 2 shows an example source code of an event source.

FIG. 3 shows an example of a log write instruction.

FIG. 4 shows an example of a log message generated by the log write instruction in FIG. 3.

FIG. 5 shows a small, eight-entry portion of a log file.

FIGS. 6A-6C show an example of the log management server receiving log messages from event sources.

FIG. 7 shown a table of examples of regular expressions designed to match particular character strings of log messages.

FIG. 8 shows a table of example date and time formats often used to record the date and time in log messages and matching regular expressions.

FIG. 9 shows a table of examples of primary Grok patterns.

FIG. 10 shows a table of examples of composite Grok patterns.

FIG. 11 shows an example of a log message and an associated Grok expression configured to match character strings of the log message.

FIG. 12 shows an implementation architecture for a log management server that generates a Grok expression graph and generates a Grok expression from a sample log message.

FIG. 13 shows a flow diagram of a method for constructing a Grok expression graph from primary and composite Grok patterns.

FIG. 14A shows an example list of primary Grok patterns.

FIG. 14B shows an example list of composite Grok patterns.

FIGS. 15A-15C show three examples of relationship graphs formed from three composite Grok patterns.

FIG. 16 shows an example of a small Grok expression graph formed from the relationship graphs shown in FIGS. 15A-15C.

FIG. 17 shows an example of a larger Grok expression graph constructed from default primary and composite Grok patterns.

FIG. 18A shows the Grok expression graph of FIG. 17 partitioned into eleven sections.

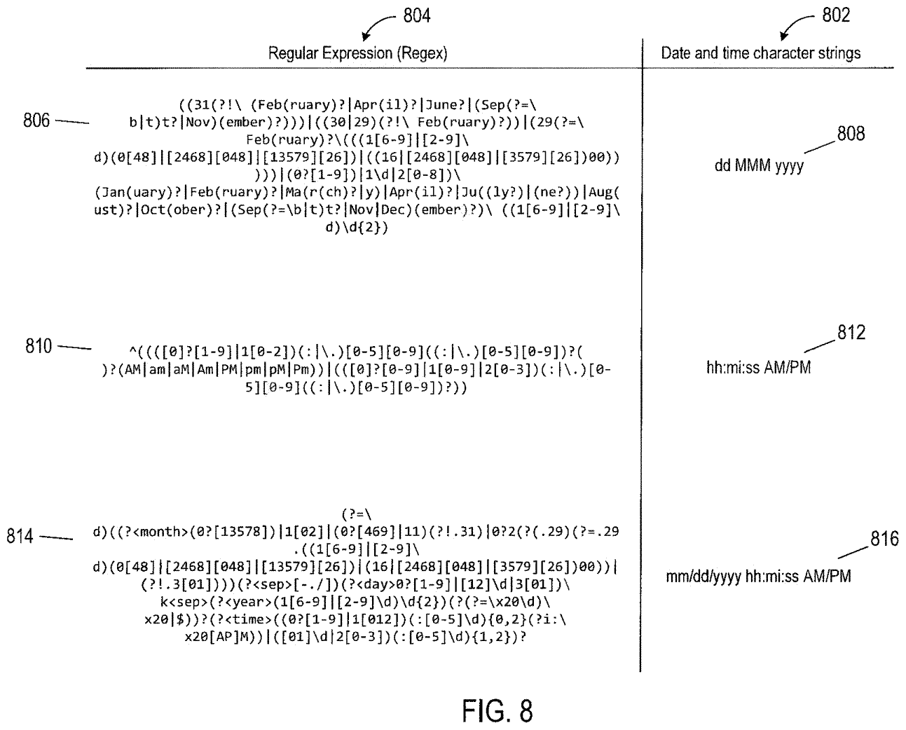

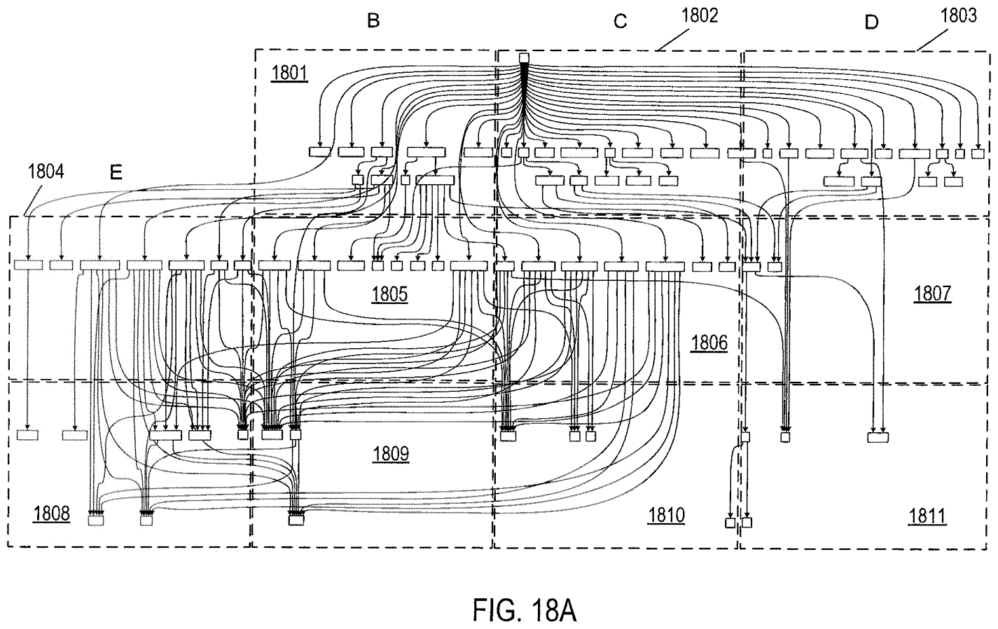

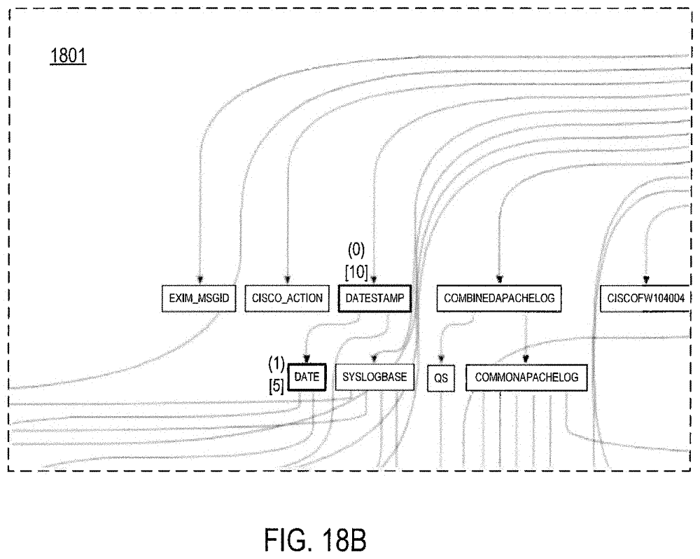

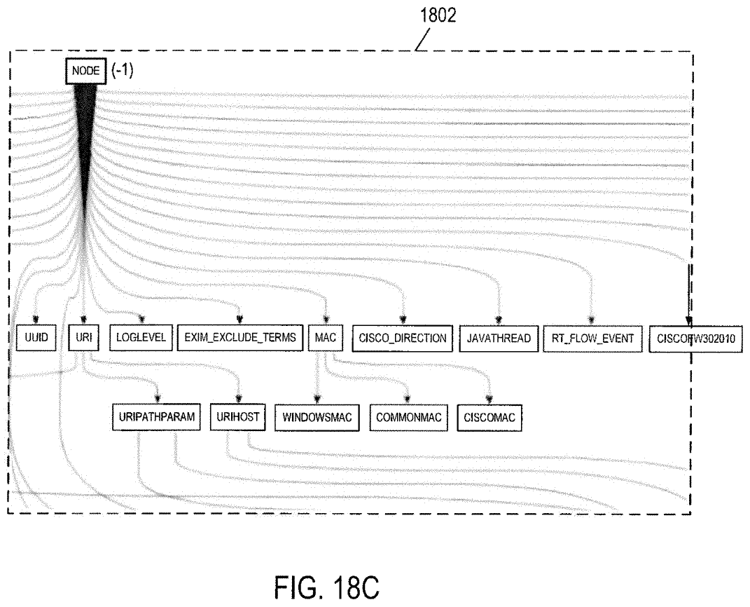

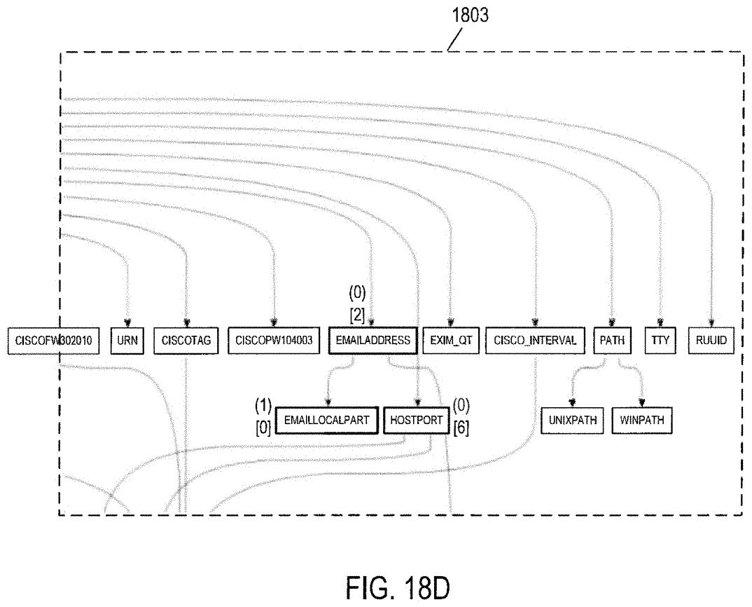

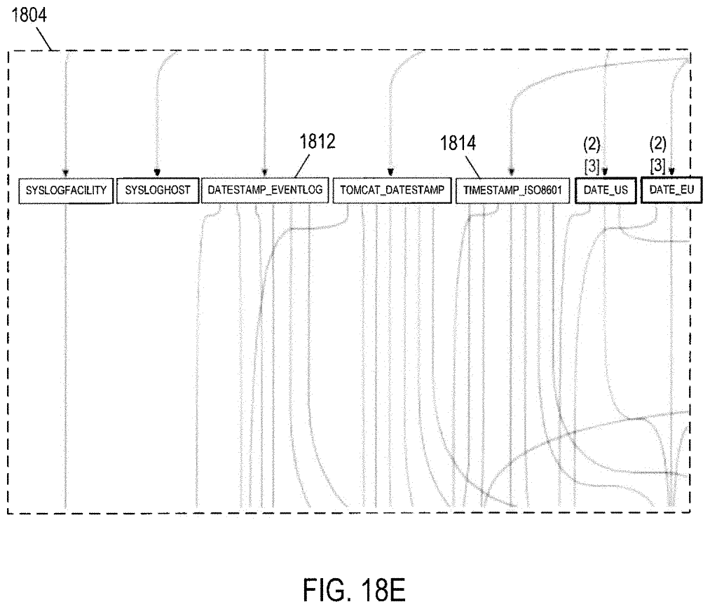

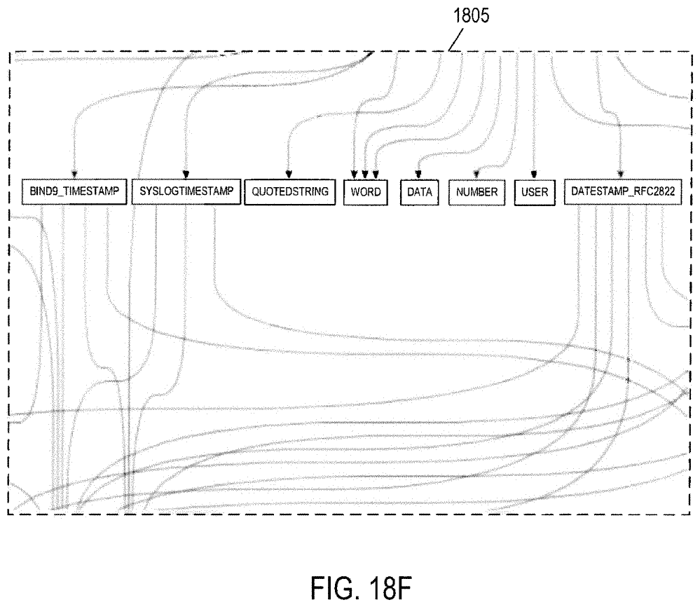

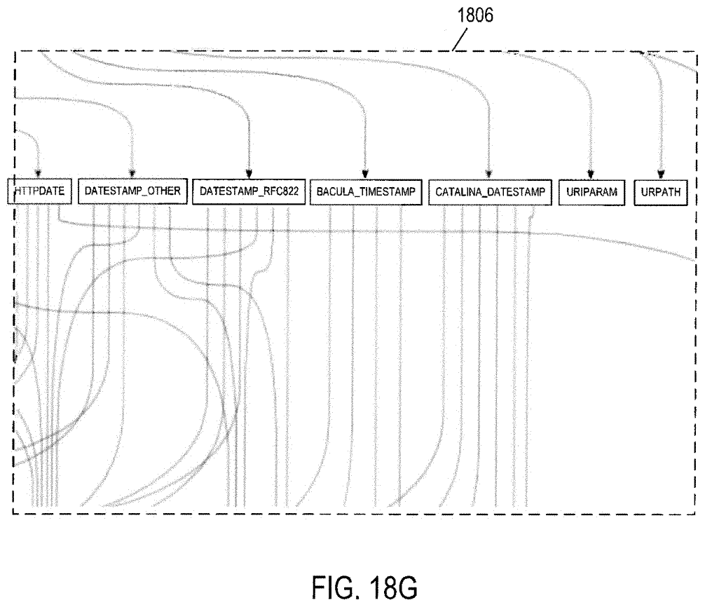

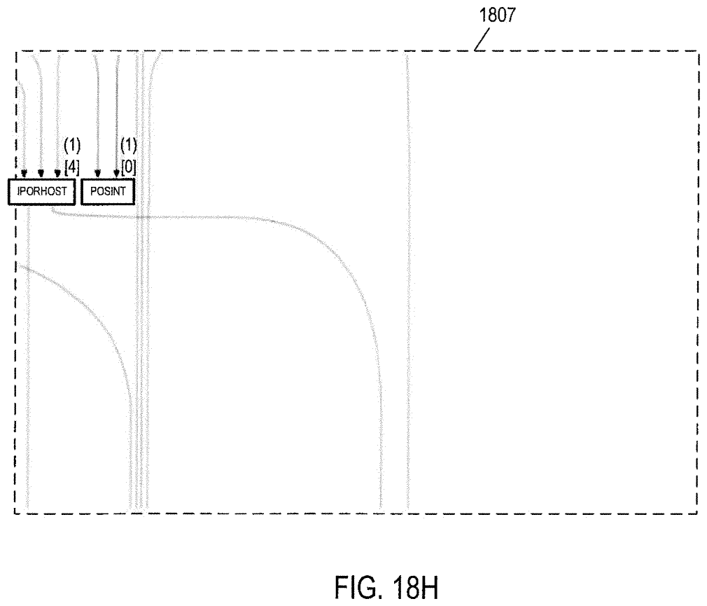

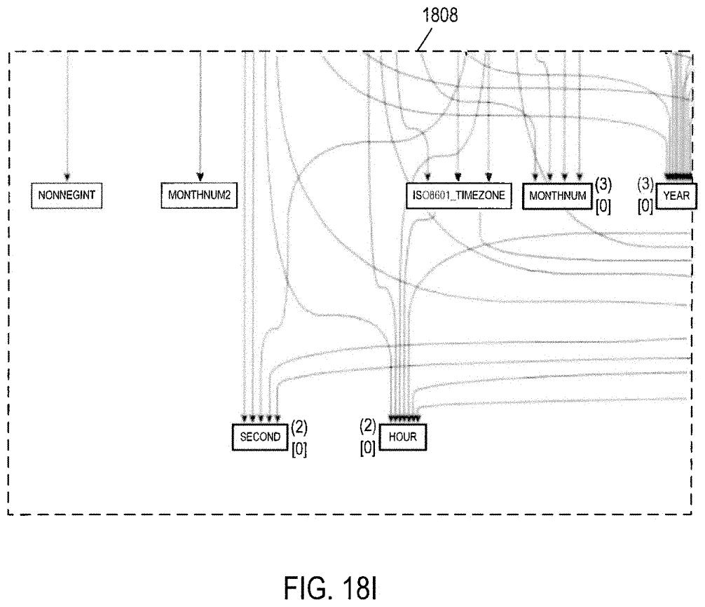

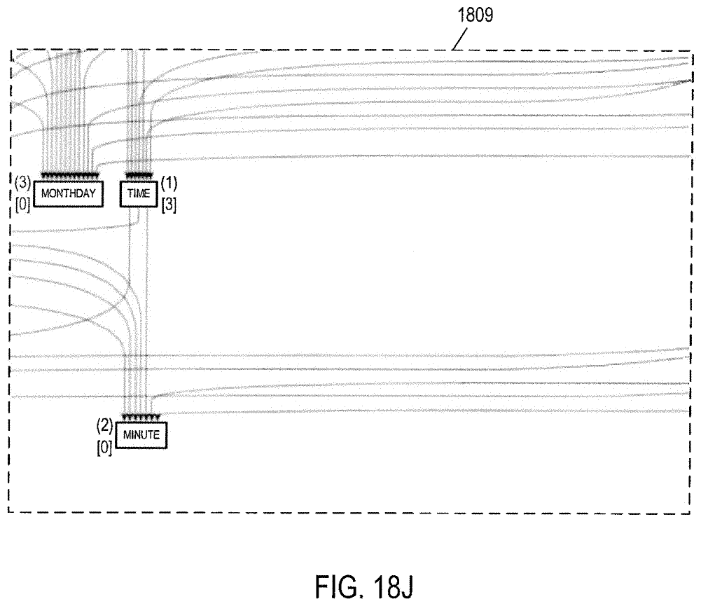

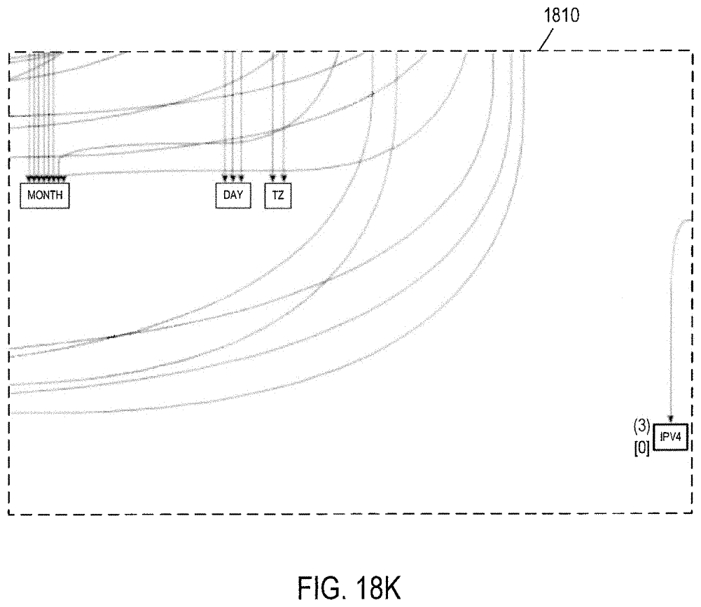

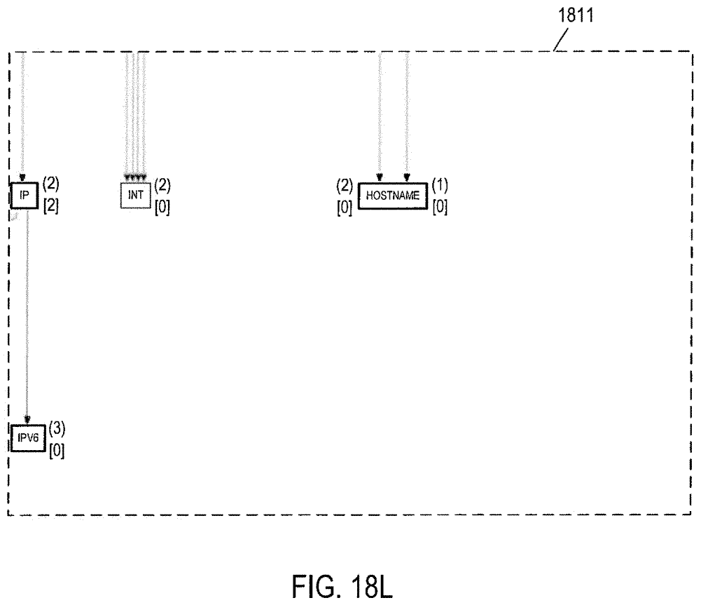

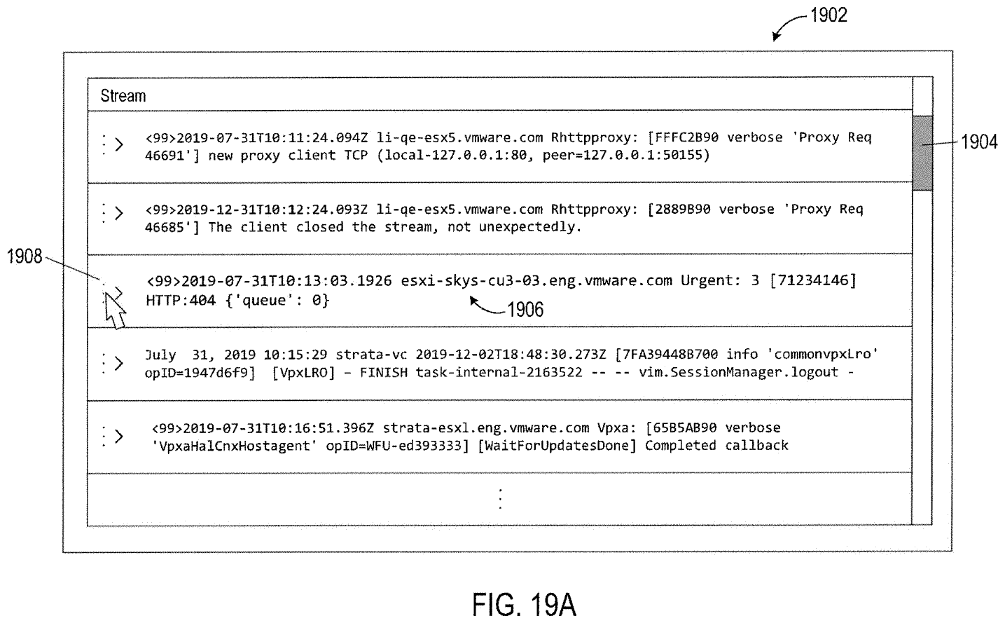

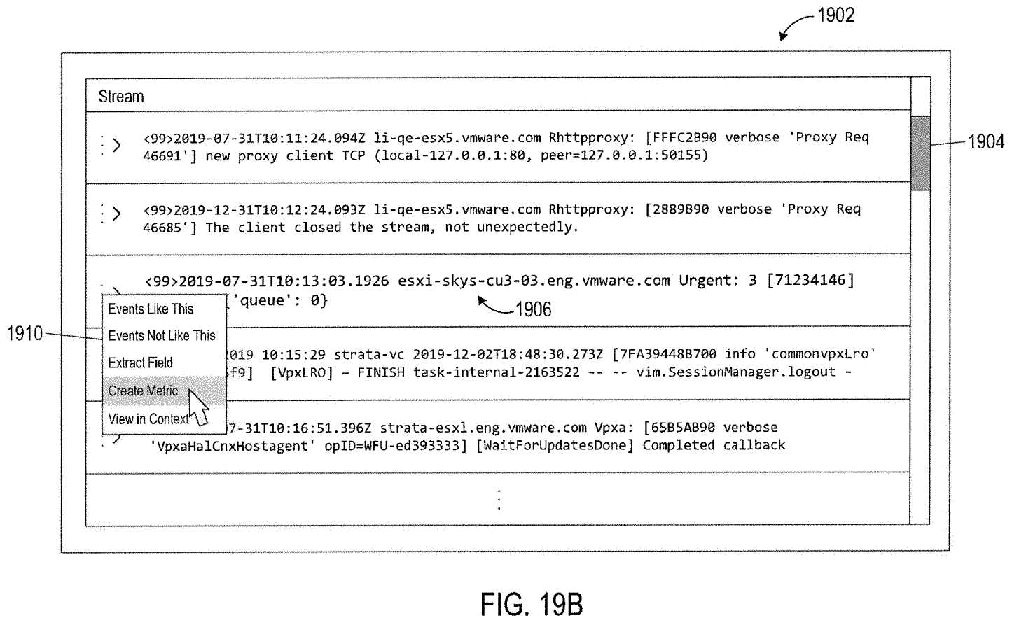

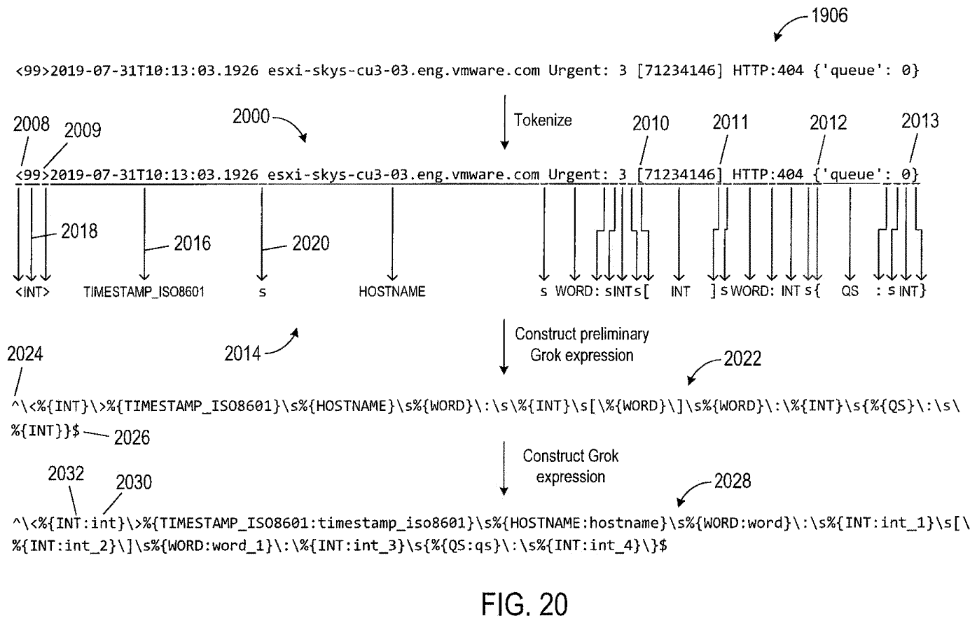

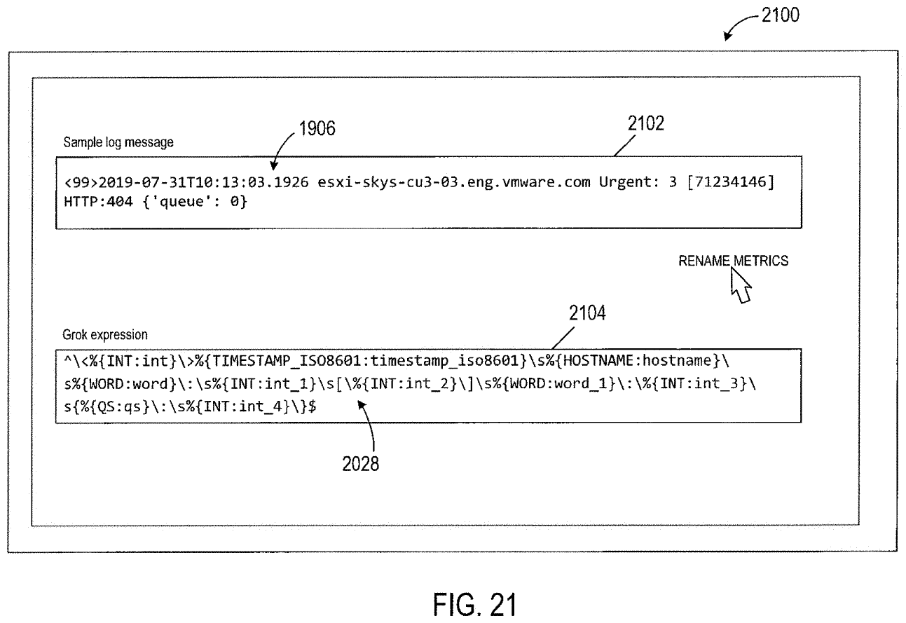

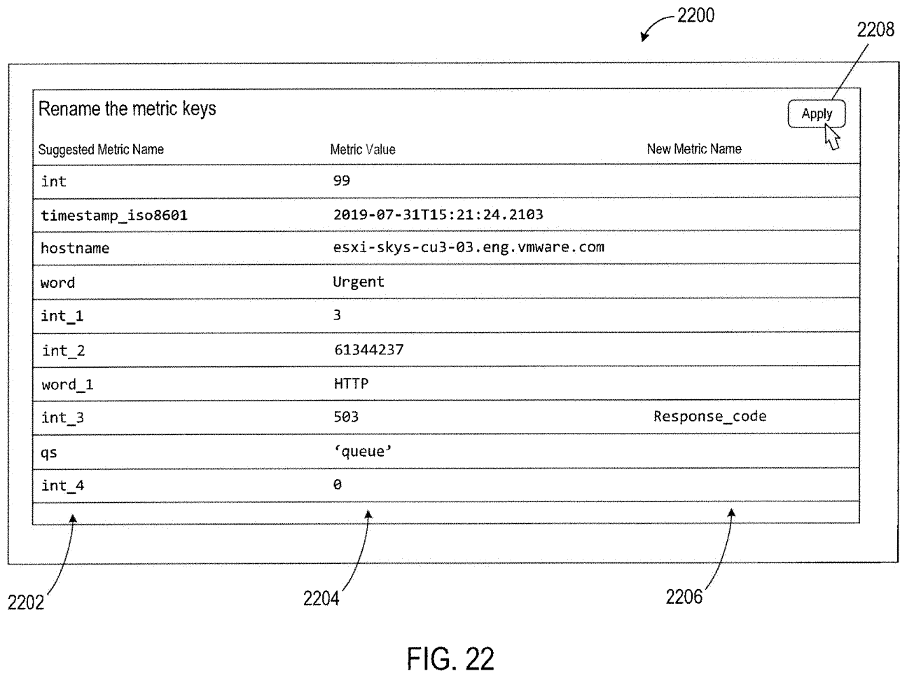

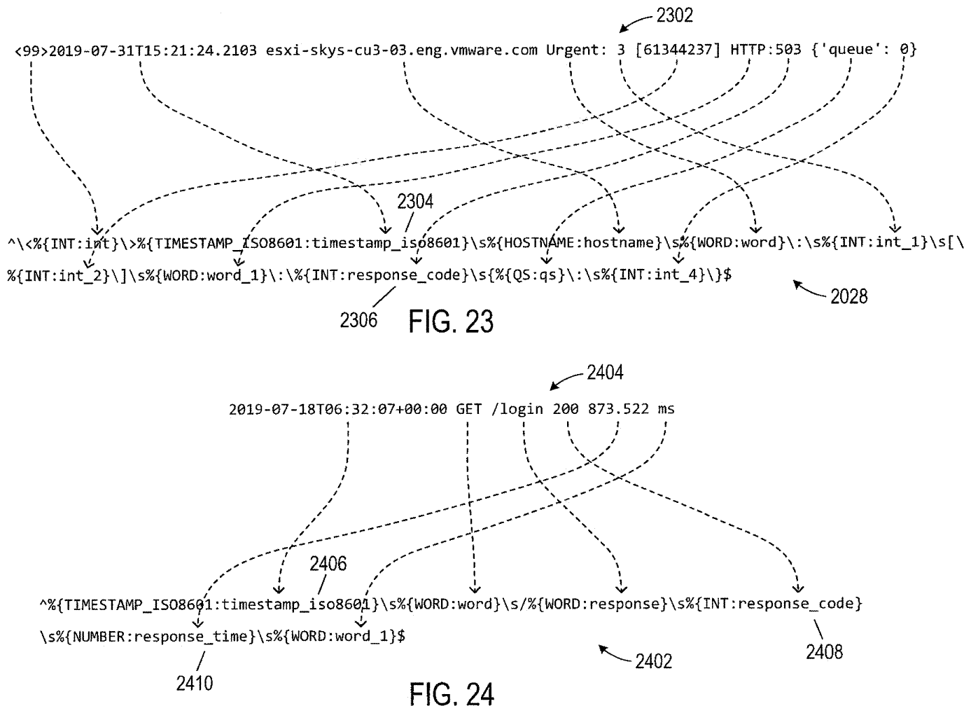

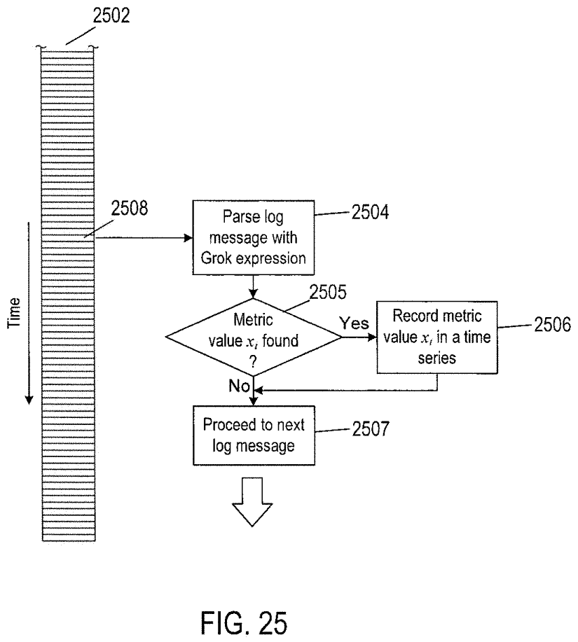

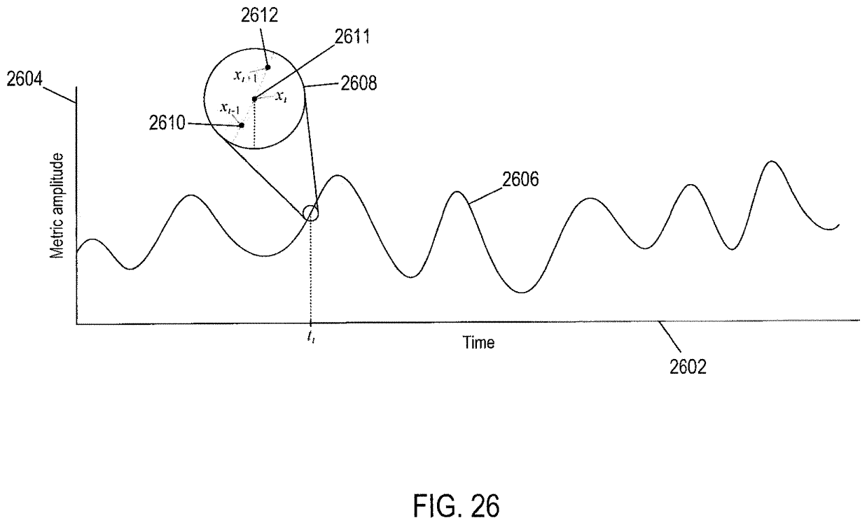

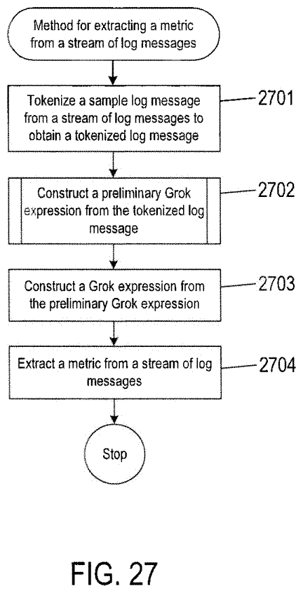

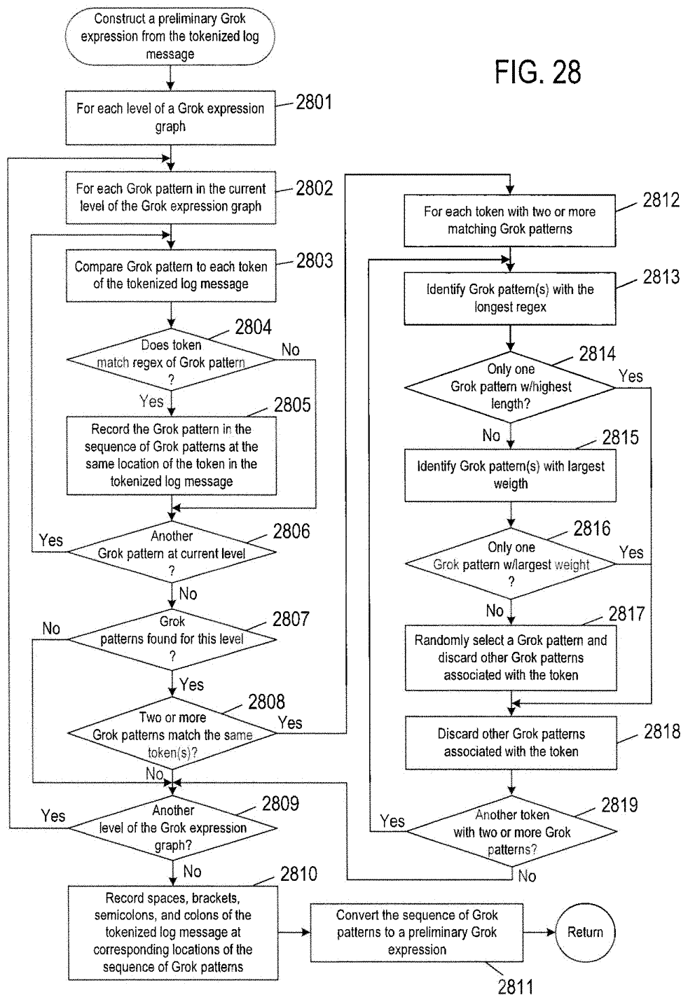

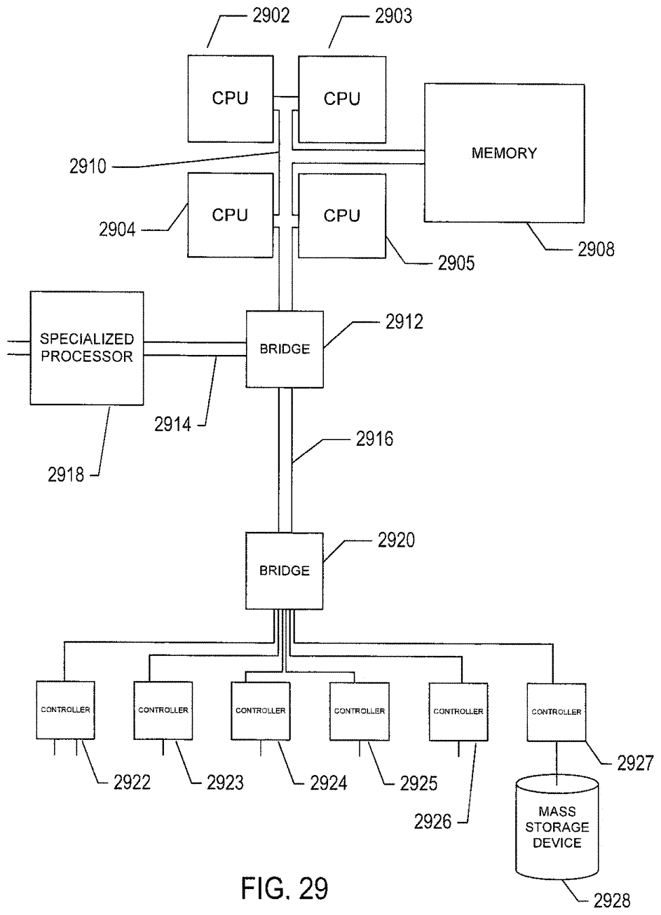

FIGS. 8B-18L show magnified views of the eleven sections shown in FIG. 18A.

FIGS. 19A-19B Show an example of a graphical user interface that enables a user to select a sample log message to use as a basis for constructing a Grok expression.

FIG. 20 shows an example of constructing a Grok expression for a sample log message using a Grok expression graph.

FIG. 21 shows a graphical user interface that displays a sample log message and an associated Grok expression.

FIG. 22 shows a graphical user interface that displays a table of variable identifiers and character strings of a sample log message.

FIG. 23 shows an example of a Grok expression used to extract character strings from a log message.

FIG. 24 shows an example of a Grok expression used to extract character strings from a log message.

FIG. 25 shows a process for extracting metric values from log messages in a stream of log messages.

FIG. 26 shows a plot of at example metric extracted from log messages.

FIG. 27 shows a flow diagram illustrating an example implementation of a “method for extracting a metric from a stream of log messages.”

FIG. 28 shows a flow diagram illustrating an example implementation of the “construct a Grok expression from the tokenized log message” performed in FIG. 27.

FIG. 29 shows an example of a computer system that executes a log management server.

### DETAILED DESCRIPTION

This disclosure is directed to automated methods and systems for generating a parsing expression for any type of log message. Methods and systems include using the parsing expression to automatically parse log messages and extract metric data from the parsed log messages. in a first subsection, log messages and log files are described below. An example of a log management server executed in a distributed computing system is described below in a second subsection. Regular expressions, Grok patterns, and Grok expressions are described below in a third subsection. Automated methods and systems for constructing Grok expressions and extracting metrics from log messages are described below in a fourth subsection.

Log Messages and Log Files

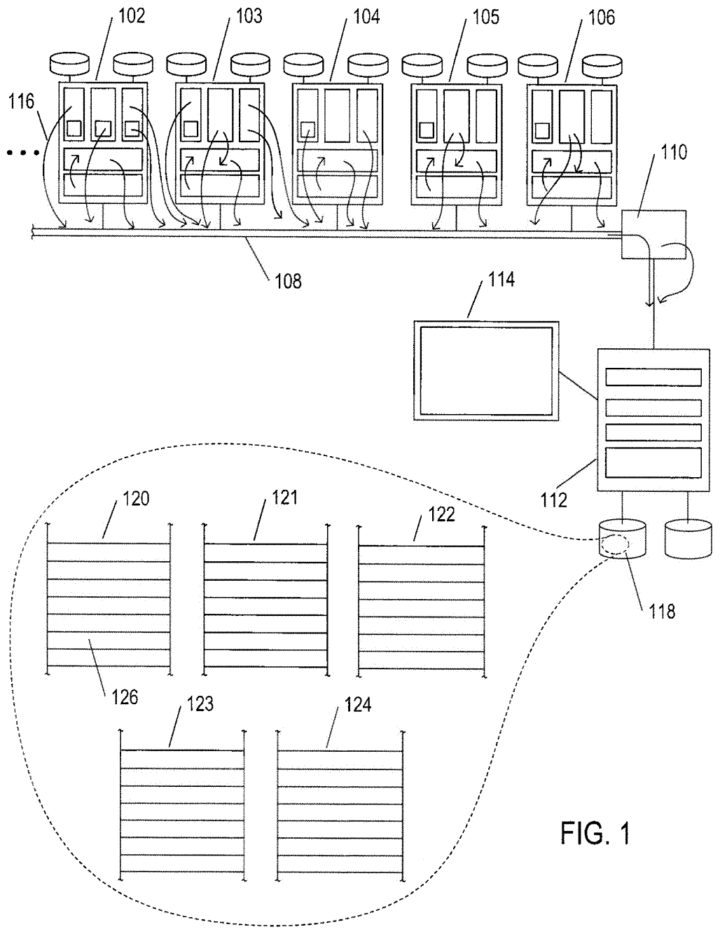

FIG. 1 shows an example of logging log messages in log files. In FIG. 1, computer systems 102-106 within a distributed computing system, such as data center, are linked together by an electronic communications medium 108 and additionally linked through a communications bridge router 110 to an administration computer system 112 that includes an administrative console 114 and executes a log management server described below. Each of the computer systems 102-106 may run a log monitoring agent that forwards log messages to the log management server executing on the administration computer system 112. As indicated by curved arrows, such as curved arrow 116, multiple components within each of the discrete computer systems 102-106 as well as the communications bridge/router 110 generate log messages that are forwarded to the log management server. Log messages may be generated by any event source. Event sutures may be, but are not limited to, application programs, operating systems, VMs, guest operating systems, containers, network devices, machine codes, event channels, and other computer programs or processes running on the computer systems 102-106, the bridge/router 110 and any other components of a data center. Log messages may be received by log monitoring agents at various hierarchical levels within a discrete computer system and then forwarded to the log management server executing in the administration computer system 112. The log management server records the log messages in a data-storage device or appliance 118 as log files 120-124. Rectangles, such as rectangle 126, represent individual log messages. For example, log file 120 may contain a list of log messages generated within the computer system 102. Each log monitoring agent has a configuration that includes a log path and a log parser. The log path specifies a unique file system path in terms of a directory tree hierarchy that identifies the storage location of a log file on the administration computer system 112 or the data-storage device 118. The log monitoring agent receives specific file and event channel log paths to monitor log files and the log parser includes log parsing rules to extract and format lines of the log message into log message fields described below. Each log monitoring agent sends a constructed structured log message to the log management server. The administration computer system 112 and computer systems 102-106 may function without log monitoring agents and a log management server, but with less precision and certainty.

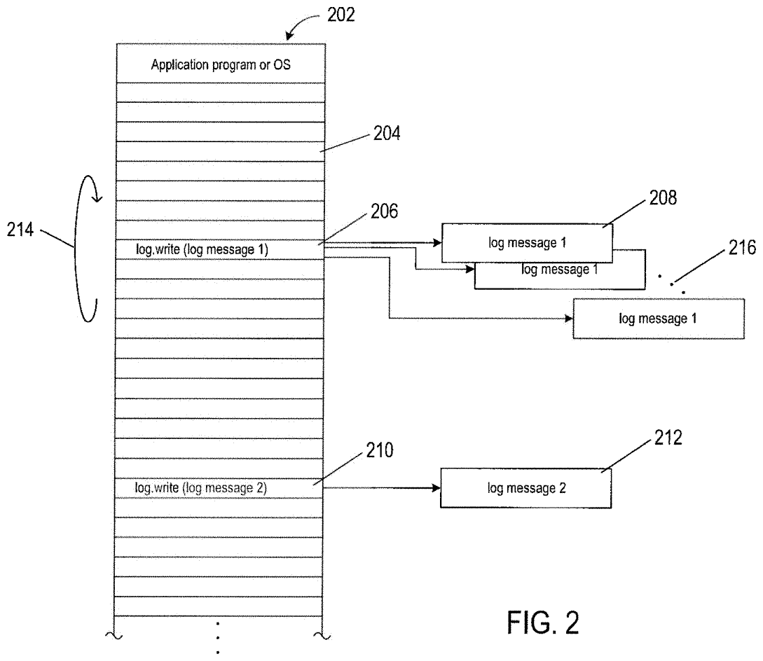

FIG. 2 shows an example source code 202 of an event source, such as an application, an operating system, a VM, a guest operating system, or any other computer program or machine code that generates log messages. The source code 202 is just one example of an event source that generates log messages. Rectangles, such as rectangle 204, represent a definition, a comment, a statement, or a computer instruction that expresses some action to he executed by a computer. The source code 202 includes log write instructions that generate log messages when certain events predetermined by a developer occur during execution of the source code 202. For example, source code 202 includes an example log write instruction 206 that when executed generates a “log message 1” represented by rectangle 208, and a second example log write instruction 210 that when executed generates “log message 2” represented by rectangle 212. In the example of FIG. 2, the log write instruction 208 is embedded within a set of computer instructions that are repeatedly executed in a loop 214. As shown in FIG. 2, the same log message 1 is repeatedly generated 216. The same type of log write instructions may also be located in different places throughout the source code, which in turns creates repeats of essentially the same type of log message in the log file.

In FIG. 2, the notation “log.write( )” is a general representation of a log write instruction. In practice, the form of the log write instruction varies for different programming languages. In general, the log write instructions are determined by the developer and are unstructured, or semi-structured, and in many case are relatively cryptic. For example, log write instructions may include instructions for time stamping the log message and contain a message comprising natural-language words and/or phrases as well as various types of text strings that represent file names, path names, and, perhaps various alphanumeric parameters that may identify objects, such as VMs, containers, or virtual network interfaces. In practice, a log write instruction may also include the name of the source of the, log message (e.g., name of the application program, operating system and version, server computer, and network device) and may include the name of the log file to which the log message is recorded. Log write instructions may be written in a source code by the developer of an application program or operating system in order to record the state of the application program or operating system at point in time and to record events that occur while an operating system or application program is executing. For example, a developer may include log write instructions that record informative events including, but are not limited to, identifying startups, shutdowns, I/O operations of applications or devices; errors identifying runtime deviations from normal behavior or unexpected conditions of applications or non-responsive devices; fatal events identifying severe conditions that cause premature termination, and warnings that indicate undesirable or unexpected behaviors that do not rise to the level of errors or fatal events. Problem-related log messages log messages indicative of a problem) can be warning log messages, error log messages, and fatal log messages. Informative log messages are indicative of a normal or benign state of an event source.

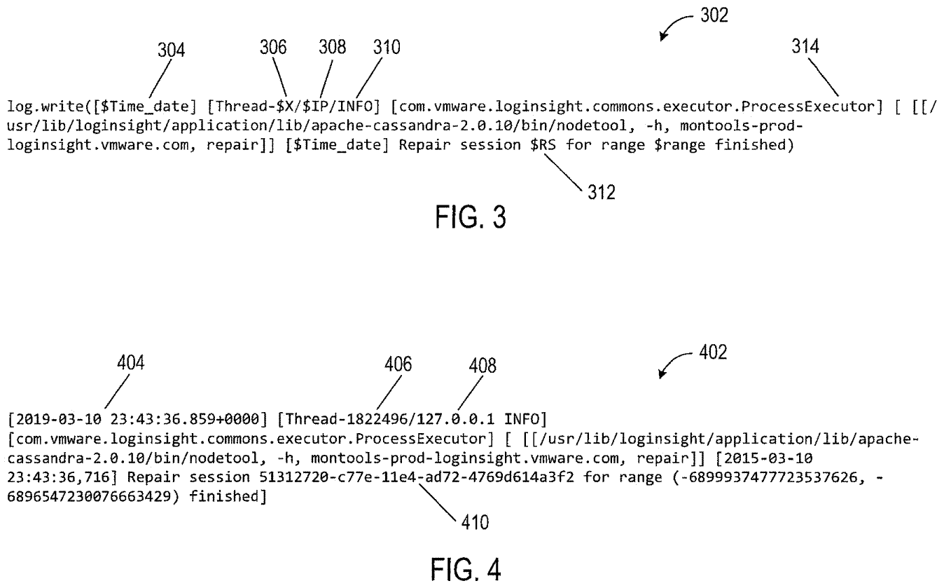

FIG. 3 shows an example of a log write instruction 302. The log write instruction 302 includes arguments identified with “$” that are filled, at the time the log message is created. For example, the log write instruction 302 includes a time-stamp argument 304, a thread number argument 306, and an internet protocol (“IP”) address argument 308. The example log write instruction 302 also includes text strings and natural-language words and phrases that identify the level of importance of the log message 310 and type of event that triggered the log write instruction, such as “Repair session” argument 312. The text strings between brackets “[ ]” represent file-system paths, such as path 314. When the log write instruction 302 is executed by a log management agent, parameters are assigned to the arguments and the text strings and natural-language words and phrases are stored as a log message of a log file.

FIG. 4 shows an example of a log message 402 generated by the log write instruction 302. The arguments of the log write instruction 302 may be assigned numerical parameters that arc recorded in the log message 402 at the time the log message is executed by the log management agent. For example, the time stamp 304, thread 306, and IP address 308 arguments of the log write instruction 302 are assigned corresponding numerical parameters 404, 406, and 408 in the log message 402. Alphanumeric expression 410 is assigned to a repair session argument 312. The time stamp 404 represents the date and time the log message 402 is generated. The text strings and natural-language words and phrases of the log write instruction 302 also appear unchanged in the log message 402 and may be used to identify the type of event (e.g., informative, warning, error, or fatal) that occurred during execution of the event source.

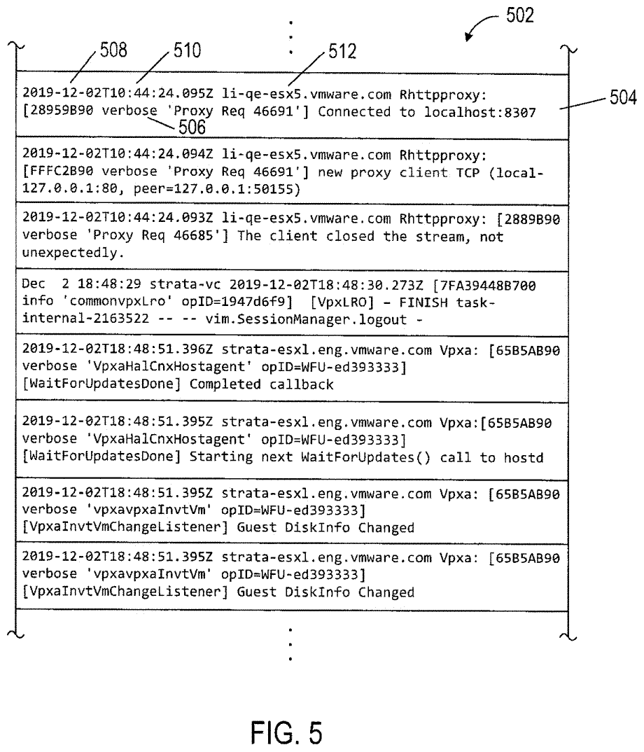

As log messages are received from various event sources, the log messages are stored in corresponding log files in the order in which the log messages are received. FIG. 5 shows a small, eight-entry portion of a log file 502. In FIG. 5, each rectangular cell, such as rectangular cell 504, of the log file 502 represents a single stored log message. For example, log message 504 includes a short natural-language phrase 506, date 508 and time 510 numerical parameters, and an alphanumeric parameter 512 that identifies a particular host computer.

Log Management Server

In large distributed computing systems, such as a data center, terabytes of log messages may be generated each day. The log messages may be sent to a log management server that records the log messages in log files that are in turn stored in data-storage appliances.

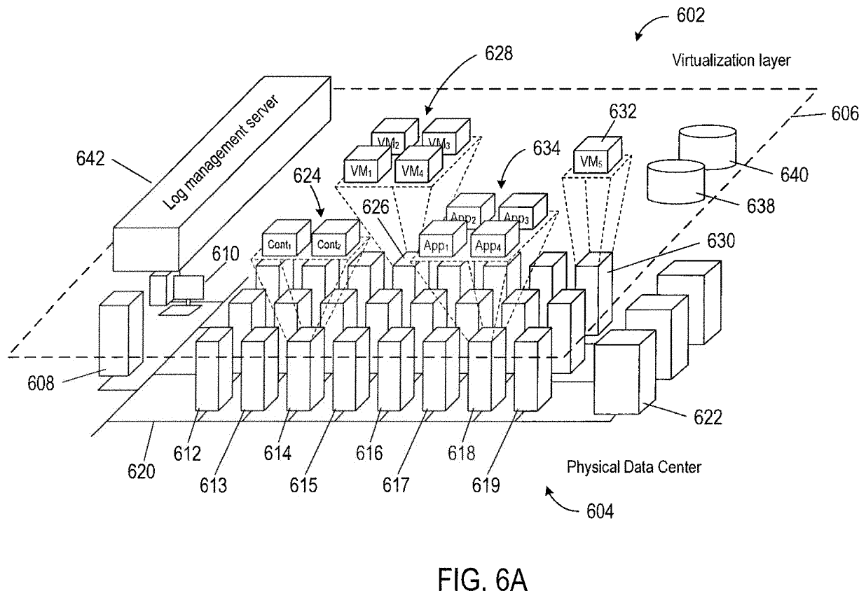

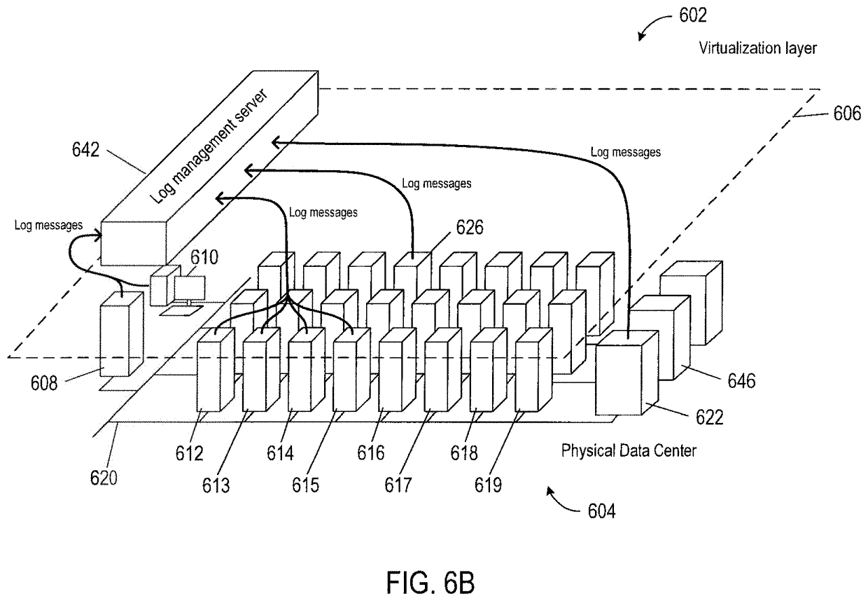

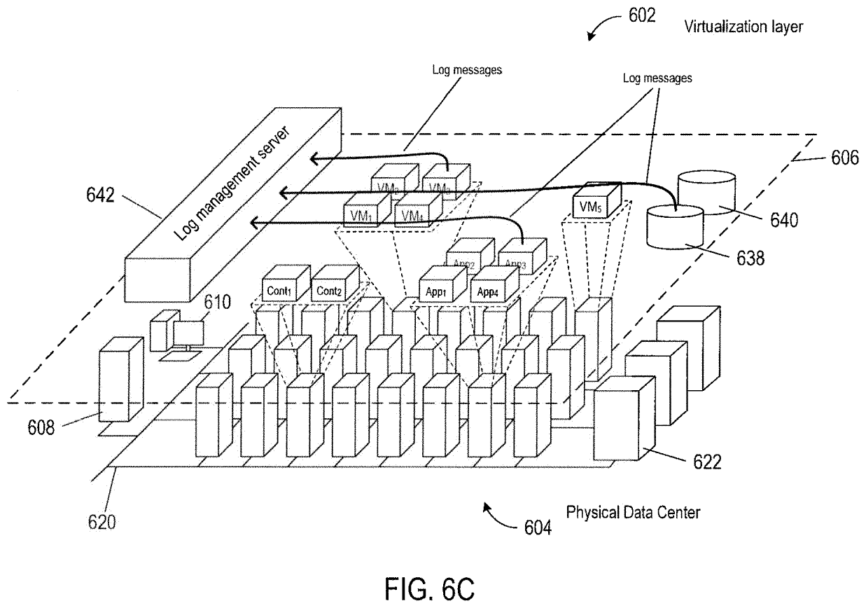

FIG. 6A shows an example of a virtualization layer 602 located above a physical data center 604. For the sake of illustration, the virtualization layer 602 is separated from the physical data center 604 by a virtual-interface plane 606. The physical data center 604 is an example of a distributed computing system. The physical data center 604 comprises physical objects, including an administration computer system 608, any of various computers, such as PC 610, on which a virtual-data-center (“VDC”) management interface may be displayed to system administrators and other users, server computers, such as server computers 612-619, data-storage devices, and network devices. The server computers may be networked together to form networks within the data center 604. The example physical data center 604 includes three networks that each directly interconnects a bank of eight server computers and a mass-storage array. For example, network 620 interconnects server computers 612-619 and a mass-storage array 622. Different physical data centers may include many different types of computers, networks, data-storage systems and devices connected according to many different types of connection topologies. The virtualization layer 602 includes virtual objects, such as VMs, applications, and containers, hosted by the server computers in the physical data center 604. The virtualization layer 602 may also include a virtual network (not illustrated) of virtual switches, routers, load balancers, and network interface cards formed from the physical switches, routers, and network interface cards of the physical data center 604. Certain server computers host VMs and containers as described above. For example, server computer 614 hosts two containers 624, server computer 626 hosts four VMs 628, and server computer 630 hosts a VM 632. Other server computers may host applications as described above with reference to FIG. 4. For example, server computer 618 hosts four applications 634. The virtual-interface plane 606 abstracts the resources of the physical data center 604 to one or more VDCs comprising the virtual objects and one or more virtual data stores, such as virtual data stores 638 and 640. For example, one VDC may comprise VMs 628 and virtual data store 638. Automated methods and systems described herein may be executed by a log management server 642 implemented in one or more VMs on the administration computer system 608. The log management server 642 receives log messages generated by event sources and records the log messages in log files as described below.

FIGS. 6B-6C show the example log management server 642 receiving log messages from event sources. Directional arrows represent log messages sent to the log management server 642. In FIG. 6B, operating systems and applications running on PC 610, server computers 608 and 644, network devices, and mass-storage array 646 send log messages to the log management server 642. Operating systems and applications running on clusters of server computers may also send log messages to the log management server 642. For example, a cluster of server computers 612-615 sends log messages to the log management server 642. In FIG. 6C, guest operating systems, VMs, containers, applications, and virtual storage may independently send log messages to the log management server 642.

Regular Expressions, Grok Patterns, and Grok Expressions

The log management server 642 executes automated methods and systems for generating a parsing expression for extraction of parameters from a type of log message. The parsing expressions for extracting parameters from log messages are based on regular expressions. A regular expression, also called “regex,” is a sequence of symbols that defines a search pattern in a text data, such as a log message. In other words, regular expressions are a system for matching patterns in text data, such as log messages. Each regex symbol matches a single character in a log message. The follow description of regular expressions and examples of regular expressions is not intended to be an exhaustive description of regular expressions and their use to match characters and character strings in log messages.

Many regex symbols match themselves, such as regex symbols for letters and numbers. For example, the regex symbol “a” matches the letter “a,” but not the letter “b,” and the regex symbol “100” matches the number “100,” but not the number 101 or a combination of letters abcdef. The regex symbol “.” matches any character. For example, the regex symbol “.art” matches the words “dart,” “cart,” and “tart,” but does not match the words “art” “hurt,” and “dark.” A regex followed by an asterisk “*” matches zero or more occurrences of the regex. A regex followed by a plus sign “+” matches one or more occurrences of a one-character regex. A regular expression followed by a questions mark “?” matches zero or one occurrence of a one-character regex. For example, the regex “a*b” matches b, ab, and aaab but does not match “baa.” The regex “a+b” matches ab and aaab but does not match b or baa. Other regex symbols include a “\d” that matches a digit in 0123456789, a “\s” that matches a white space, and a “\b” that matches a word boundary. A string of characters enclosed by square brackets, [ ], matches any one character in that string. A minus sign “−” within square brackets indicates a range of consecutive ASCII characters. For example, the regex [aeiou] matches any vowel, the regex [a-f] matches a letter in the letters abcdef, the regex [0-9] matches a 0123456789, the regex [._%+−] matches any one of the characters ._%+−. The regex [0-9a-f] matches a number in 0123456789 and a single letter in abcdef. For example, [0-9a-f] matches a6, i5, and u2 but does not match ex, 9v, or %6. Regular expressions separated a vertical bar “|” represent an alternation to match the regex on either side of the bar. For example, the regular expression Get|GetValue|Set|SetValue matches any one of the list of names: Get, GetValue, Set, or SetValue. The braces “{ }” following square brackets may be used to match more than one characters enclosed by the square brackets. For example, the regex [0-9]{2} matches two digit numbers, such as 14 and 73 but not 043 and 4, and the regex [0-9]{1-2} matches an number between 0 and 99, such as 3 and 58 but not 349.

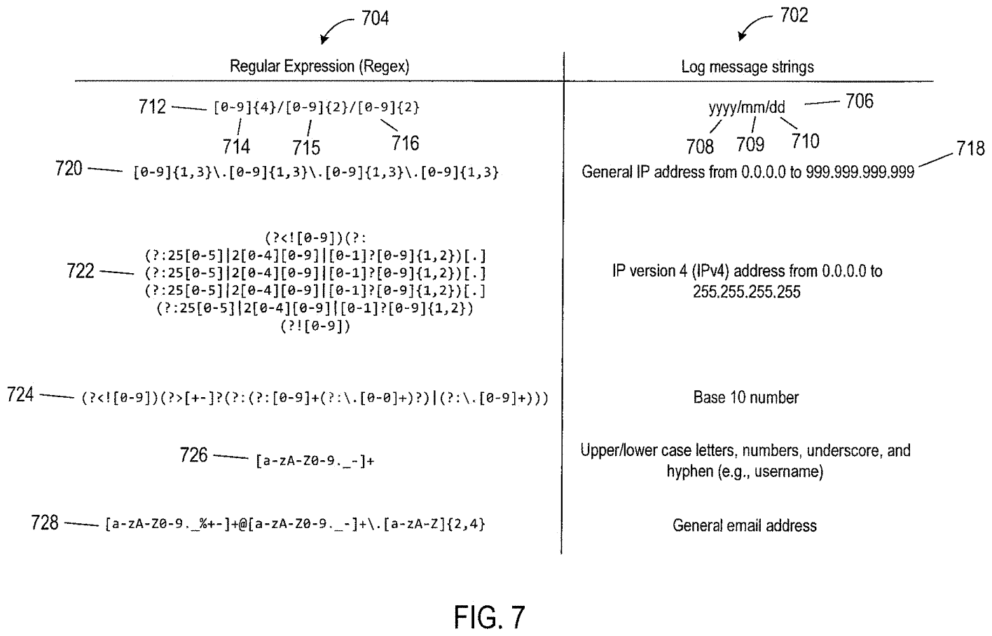

Simple regular expressions are combined to form larger regular expressions that match character strings of log messages. FIG. 7 shown a table of examples of regular expressions designed to match particular character strings of log messages. Column 702 list six different types of strings that may be found in log messages. Column 704 list six regular expressions that match the character strings listed in column 702. For example, an entry 706 of column 70 represents a format for a date used in the time stamp of mans types of log messages. The date is represented with a four-digit year 708, a two-digit month 709, and a two-digit day 710 separated by slashes. The regex 712 includes regular expressions 714-716 separated by slashes. The regular expressions 714-716 match the characters used to represent the year 708, month 709, and day 710. Entry 718 of column 702 represents a general format for internet protocol (“IP”) addresses. A typical general IP address comprises four numbers. Each number ranges from 0 to 999 and each pair of numbers is separated by a period, such as 27.0.15.123. Regex 720 in column 704 matches a general IP address. The regex [0-9]{1-3} matches a number between 0 and 999. The backslash “\” before each period indicates the period is part of the IP address and is different from the regex symbol “.” used to represent any character. Regex 722 matches any IPv4 address. Regex 724 matches any base-10 number. Regex 726 matches one or more occurrences of a lower-case letter, an upper-case letter, a number between 0 and 9, a period, an underscore, and a hyphen in a character string. Regex 728 matches email addresses. Regex 728 includes the regex 726 after the ampersand symbol.

Regular expressions are specifically designed to match a particular string of characters in log messages and can be become lengthy and extremely complex. For example, because log messages are unstructured, different types of regular expressions are configured to match various different character strings used to record a date and time in the time stamp portion of a log message.

FIG. 8 shows a table of example date and time formats often used to record the date and time in log messages and matching regular expressions. Column 802 displays different formats for representing a date and time in log messages. Column 804 represents regular expressions that match the date and time formats listed in column 802. Regex 806 matches a date with the format 808 in which the month may be recorded in full or using the first three letters. For example, regex 806 matches a date in which the month is written in full, such as 3 Oct. 2020. Regex 806 also matches a date in which the month is abbreviated by the first three letters of the month, such as 29 Feb. 2019. Regular expression 810 matches three different formats for recording time using a twelve or a twenty-four hour clock represented by a format 812 with a two-digit hour, a two-digit minute, and a two-digit seconds 710 separated by colons followed by am or pm. For example, regex 810 matches a twelve-hour clock time without seconds 6:01 AM, a twelve-hour clock time with seconds 04:27:42 am, or a twenty-four hour clock time 22:51:11. Regex 814 matches different formats for date and time in which the month, day, hours, and minutes may be represented using single digits. For example, regex 814 matches a date and time format 1/31/2020 and 5:25:23 PM or a date and time format 11/5/2020 and 11:7:23 AM.

Grok patterns ate predefined symbolic representations of regular expressions that reduce the complexity of manually constructing regular expressions. Grok patterns may be categorized as either primary Grok patterns or composite Grok patterns that are formed from primary Grok patterns. A Grok pattern is called and executed using the notation Grok syntax %{Grok pattern}.

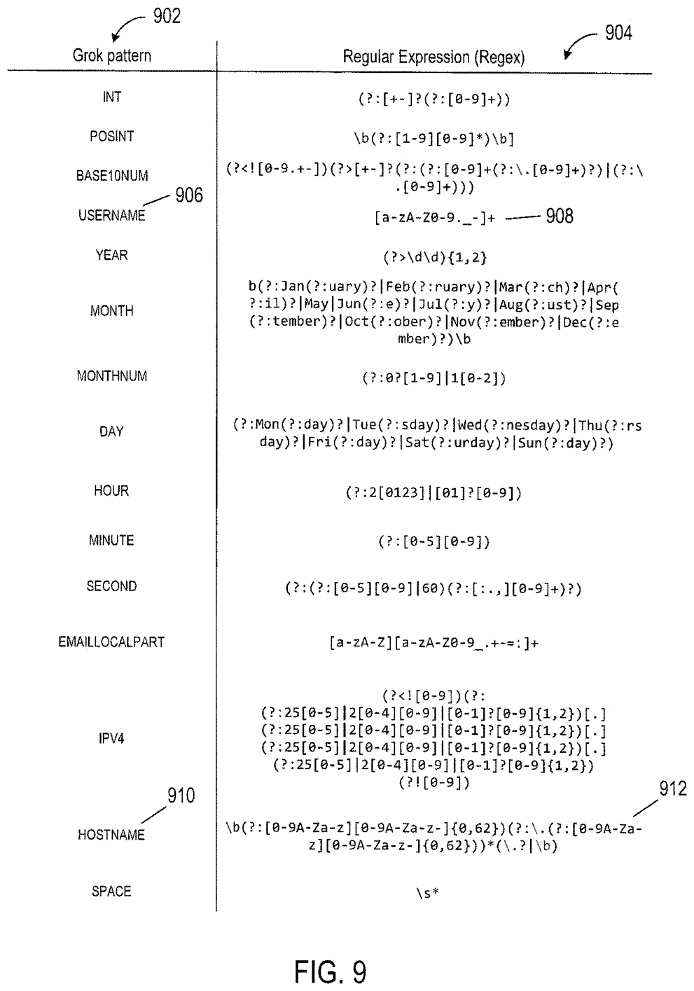

FIG. 9 shows a table of examples of primary Grok patterns and corresponding regular expressions. Column 902 contains a list of primary Grok patterns. Column 904 contains a list of regular expressions represented by the Grok patterns in column 902. For example, the Grok pattern “USERNAME” 906 represents the regex 908 that matches one or more occurrences of a lower-case letter, an upper-case letter, a number between 0 and 9, a period, an underscore, and a hyphen in a character string. Grok pattern “HOSTNAME” 910 represents the regex 912 that matches a hostname. A hostname comprises a sequence of labels that are concatenated with periods. Note that the list of primary Grok patterns shown in FIG. 9 is not an exhaustive list of primary Grok patterns.

A composite Grok pattern comprises two or more primary Grok patterns. Composite Grok patterns may also be formed from combinations of composite Grok patterns and combinations of composite Grok patterns and primary Grok patterns.

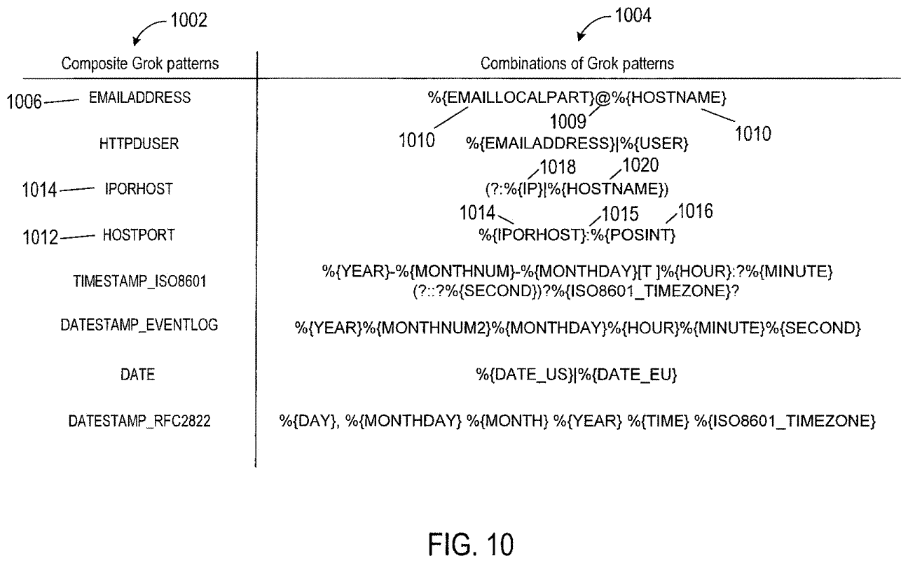

FIG. 10 shows a table of examples of composite Grok patterns. Column 1002 contains a list of composite Grok patterns. Column 1004 contains a list of combinations of Grok patterns that are represented by the Grok patterns in column 1002. For example, composite Grok pattern “EMAILADDRESS” 1006 comprises a combination of “EMAILLOCALPART” 1008, an ampersand 1009, and “HOSTNAME” 1010. The Grok patterns “EMAILLOCALPART” 1008 and “HOSTNAME” 1010 are primary Grok patterns listed in the table shown in FIG. 9. The composite Grok pattern “EMAILADDRESS” 1006 matches the format of nearly any email address. Composite Grok pattern “HOSTPORT” 1012 is a combination of a composite Grok pattern “IPORHOST” 1014, a colon 1015, and a primary Grok pattern “POSINT” 1016. The composite Grok pattern “IPORHOST” 1014 is a composite Grok pattern formed from primary Grok pattern “IP” 1018 and primary Grok pattern “HOSTNAME” 1020. Note that the list of composite Grok patterns shown in FIG. 10 is not an exhaustive list of composite Grok patterns.

Composite Grok patterns also include user defined Grok patterns, such as composite Grok patterns defined by a system administrator or an application owner. User defined Grok patterns may be formed from any combination of composite and/or primary Grok patterns. For example, a user may define a Grok pattern MYCUSTOMPATTERN as the combination of Grok patterns %{TIMESTAMP_ISO8601} and %{HOSTNAME}, where TIMESTAMP_ISO8601 is a composite Grok pattern listed in the table of FIG. 10 and HOSTNAME is a primary Grok pattern listed in the table of FIG. 9.

Grok patterns may be used to map specific character strings into dedicated variable identifiers. Grok syntax for using. a Grok pattern to map a character string to a variable identifier is given by:

%{GROK_PATTERN:variable_name}

where

GROK_PATTERN represents a primary or composite Grok pattern; and

variable_name is a variable identifier assigned to a character string in text data that matches the GROK_PATTERN.

A Grok expression is a parsing expression that is constructed from Grok patterns that match characters strings in text data and may be used to parse character strings of a log message. Consider, for example, the following simple example segment of a log message:
34.5.243.1 GET index.html 14763 0.064

A Grok expression that may be used to parse the example segment is given by:

\hat{ }%{IP:ip_address}\s%{WORD:word}\s%{URIPATHPARAM:request}\s

%{INT:bytes}\s%{NUMBER:duration}$

The hat symbol “\hat{ }” identifies the beginning of a Grok expression. The dollar sign symbol “$” identifies the end of a Grok expression. The symbol “\s” matches spaces between character strings in the example segment. The Grok expression parses the example segment by assigning the character strings of the log message to the variable identifiers of the Grok expression as follows:
ip_address: 34.5.243.1
word: GET
request: index.html
bytes: 14763
duration: 0.064

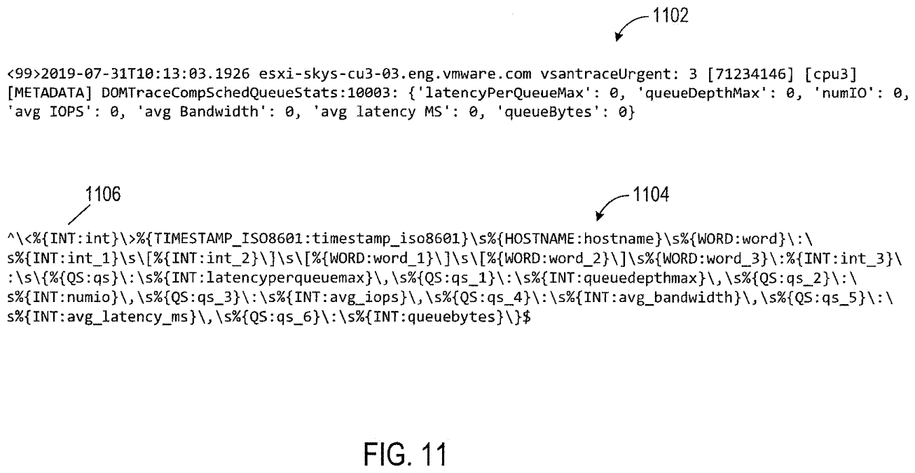

FIG. 11 shows an example of a log message 1102 and an associated Grok expression 1104 configured to parse the log message 1102. The Grok expression 1104 begins with hat symbol “\hat{ }” and ends with the dollar sign symbol “$”. The Grok patterns extract character strings from the log message and assign the character strings to corresponding variable identifiers. For example, the Grok pattern %{INT:int} 1106 is located between angled brackets < and > and matches the location of the integer “99” in the log message 1102. When the Grok expression 1104 is executed, the variable identifier “int” is assigned the value 99.

Grok expressions are formed from Grok patterns and may be used to parse character strings of log messages. Because each Grok expression is unique to a type or format of text data recorded in a log message, a user has to manually construct a Grok expression that matches each of the character strings and punctuation of a type of log message. Although Grok patterns appear simpler to implement than regular expressions, manual construction of Grok expressions to parse log messages is error prone and time consuming. Manual construction of a Grok expression to match a type of log message includes selecting Grok patterns that match corresponding character strings and making sure to include braces, brackets, and other punctuation of the type of log message. A single error in the choice of a Grok pattern, location of a Grok pattern, and/or placement of punctuation in a Grok expression renders the Grok expression unsuitable for parsing character strings of log messages that belong to a type log message. As a result, a Grok expression with errors fails to extract valuable parameters, such as metrics, which are useful for troubleshooting problems and performing root cause analysis of problems in a data center or another distributed computing system.

Automated Methods and Systems for Constructing Grok Expressions and Extracting Metrics from Log Messages

Automated methods and systems for constructing Grok expressions from log messages are now described. The automated methods and systems eliminate the error prone and time-consuming task of manually constructing Grok expressions to parse log messages. Method and systems include construction of a Grok expression graph from primary and composite Grok patterns. The Grok expression graph is used to construct a Grok expression from a sample log message of a particular type of log messages. The Grok expression may then be used to parse log messages that belong to the type of log messages and extract metrics from the log messages. The metrics may in turn be used to troubleshoot problems and/or identify potential root causes of problems in a data center or other type of distributed computing system.

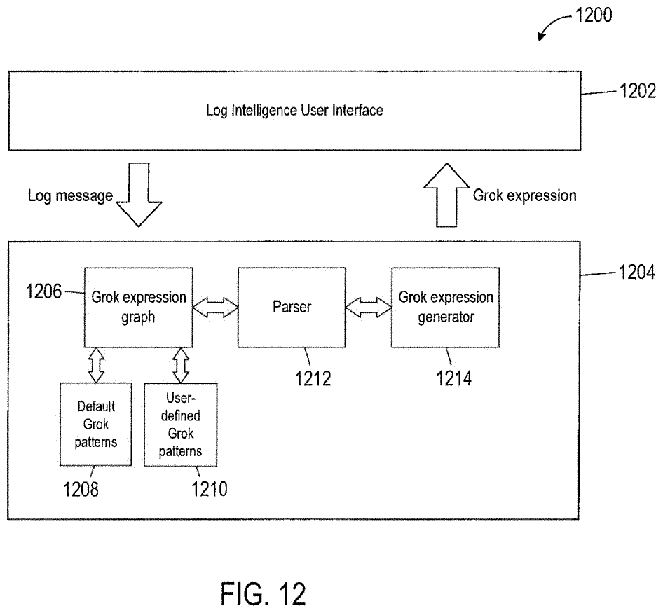

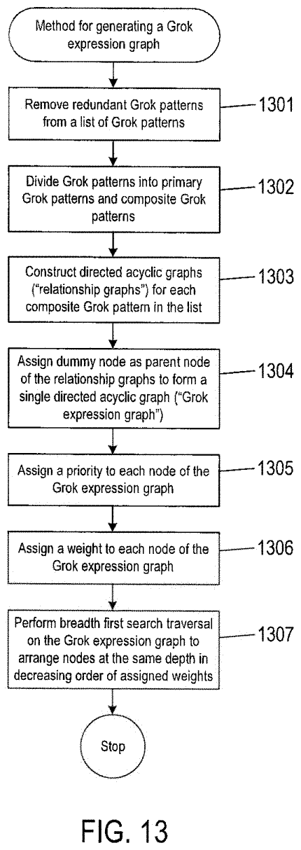

FIG. 12 shows an implementation architecture 1200 for a log management server that generates a Grok expression graph and generates a Grok expression from a user selected log message called a “sample log message.” For example, the sample log message belongs to a type of log messages that contain desired metric data for troubleshooting and root cause analysis. The implementation architecture comprises a log intelligence graphical user interface (“GUI”) 1202 displayed on a monitor and a Grok expression manager 1204. The user interface 1202 enables a user to select a sample log message from log message streams sent to the log management server and command creation of a Grok expression that is created by the Grok expression manager 1204. The Grok expression manager 1204 includes a Grok expression graph generator 1206 that generates and maintains a Grok expression graph based on default Grok patterns 1208 and user defined Grok patterns 1210 as described below with reference to FIGS. 13-16. The Grok expression manager 1204 includes a parser 1212 and a Grok expression generator 1214. The parser 1212 parses character strings of the sample log message with Grok patterns of the Grok expression graph as described below with reference to FIG. 20. The Grok expression generator 1214 constructs a Grok expression in Grok syntax for each Grok pattern that matches a character string of the sample log message. The Grok expression manager 1204 displays the Grok expression in the GUI 1202. The GUI 1202 also enables a user to specifically reset variable identifiers for the Grok expression.

FIG. 13 shows a flow diagram of a method for constructing a Grok expression graph from primary and composite Grok patterns. The method of FIG. 13 is performed by the Grok expression graph generator 1206 in FIG. 12. In block 1301, redundant Grok patterns are removed from a list of Grok patterns, such as a list of Grok patterns comprising the primary and composite Grok patterns listed in FIGS. 9 and 10. In block 1302, the list of Grok patterns are divided into primary and composite Grok patterns. For example, suppose a DATE is a Grok pattern comprising a redundant pattern of INTs (e.g., INT-INT-INT). Because DATA already captures the text, the INTs are redundant patterns that may be removed from the list of Grok patterns.

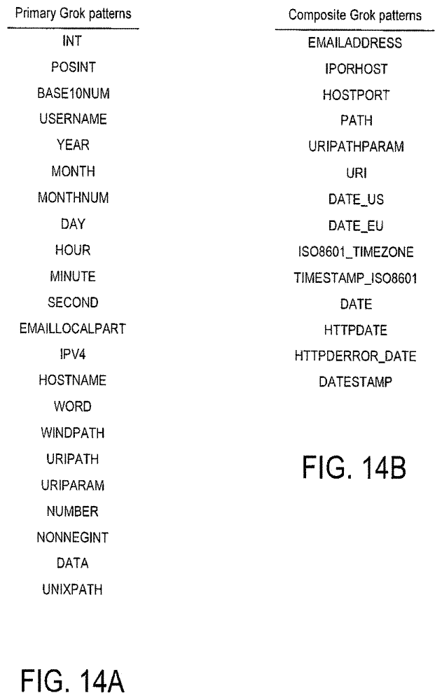

FIG. 14A shows an example list of primary Grok patterns. A primary Grok pattern represents a regex and is not formed from two or more other Grok patterns. FIG. 14B shows an example list of composite Grok patterns. Each composite Grok pattern is formed from other composite Grok patterns and/or primary Grok patterns. FIGS. 14A and 14B display lists of commonly used (i.e., default) primary and composite Grok patterns and are not intended to serve as an exhaustive list of primary and composite Grok patterns for the purpose of constructing a Grok expression graph. The list of composite Grok patterns may also include user defined Grok patterns.

Returning to FIG. 13, in block 1303, a directed acyclic graph, called a relationship graph, is constructed for each composite Grok pattern. The composite Grok pattern is a parent node. Child nodes are primary or composite Grok patterns that form the parent node. Primary Grok patterns that form the parent node are child nodes or leaves of the relationship graph.

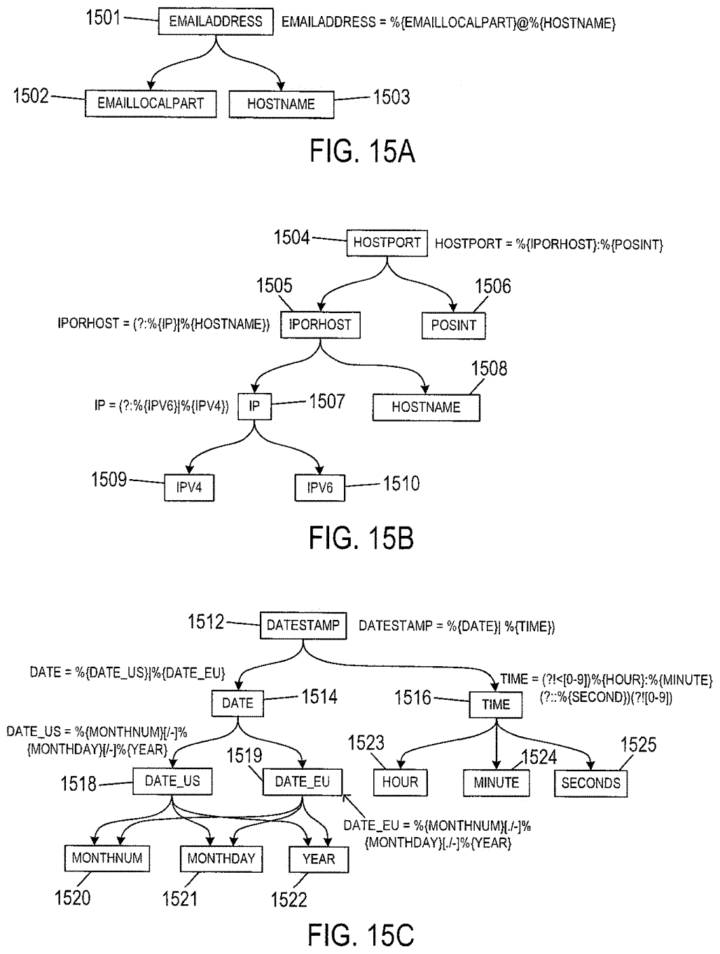

FIGS. 15A-15C show three examples of relationship graphs formed from three composite Grok patterns. The composite Grok patterns are displayed next to the nodes that represent composite Grok patterns. Directional arrows connect the parent node to the child nodes. FIG. 15A shows a relationship graph formed for the composite Grok pattern “EMAILADDRESS.” Parent node 1501 represents the composite Grok pattern “EMAILADDRESS.” Child nodes 1502 and 1503 represent the primary Grok patterns, respectively, that form the composite Grok pattern represented by the parent node 1501 and are leaves of the relationship graph. Directional arrows connect the parent node 1501 to the child nodes 1502 and 1503. FIG. 15B shows a relationship graph formed for the composite Grok pattern “HOSTPORT.” Parent node 1504 represents the composite Grok pattern “HOSTPORT.” Child nodes 1505 and 1506 represent the Grok patterns that form the parent node 1504. Child node 1506 is a leaf node of the relationship graph. The child node 1505 represents the composite Grok pattern “IPORHOST.” Child nodes 1507 and 1508 represent the Grok patterns that form the child node 1505. Child node 1508 is a leaf node of the relationship graph. The child node 1507 represents the composite Grok pattern “IP.” Child nodes 1509 and 1510 represent primary Grok patterns that form the composite Grok pattern represented by node 1507 and are leaves of the relationship graph. FIG. 15C shows a relationship graph formed for the composite Grok pattern “DATESTAMP.” Parent node 1512 represents the composite Grok pattern “DATESTAMP.” Child nodes 1514 and 1516 represent the Grok patterns that form the parent node 1512. The child node 1514 represents the composite Grok pattern “DATE.” Child node 1516 represents the composite Grok pattern “TIME.” Child nodes 1518 and 1519 represent the Grok patterns that form the child node 1514 and are in turn composed of primary Grok patterns represented by child nodes 1520-1522. Child nodes 1523-1525 represent the primary Grok patterns that form the child node 1516. Child nodes 1520-1525 are leaves of the relationship graph in FIG. 15C

Returning to FIG. 13, in block 1304, a dummy node is used as a parent node of the relationship graphs constructed in block 1303. As a result, the parent nodes of the relationship graphs formed in block 1303 become child nodes of the dummy node and the relationship graphs form a single directed acyclic graph called a “Grok expression graph.”

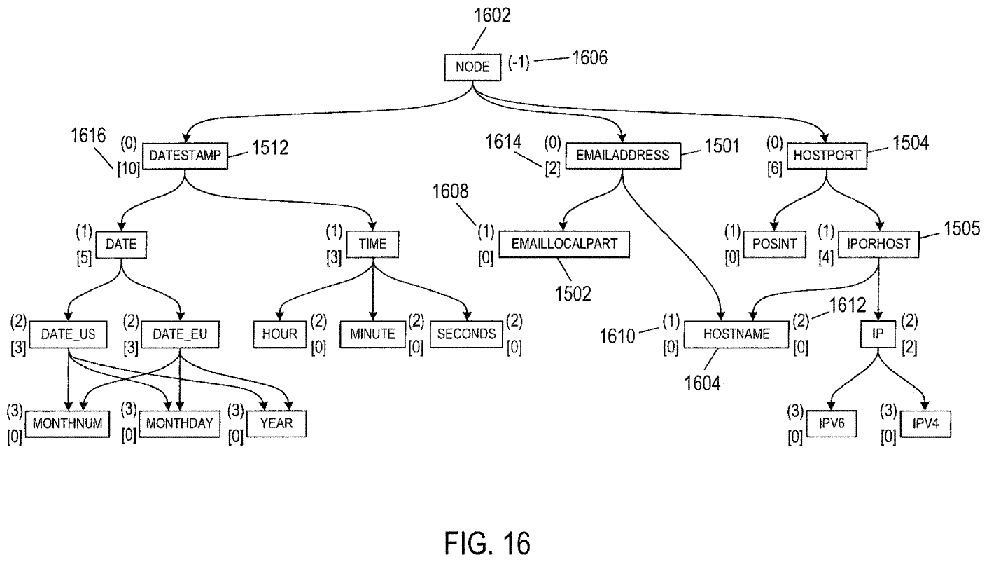

FIG. 16 shows an example of a small Grok expression graph formed from the relationship graphs shown in FIGS. 15A-15C. Node 1602 represents a dummy parent node. Parent nodes 1501, 1504, and 1512 of the relationship graphs in FIGS. 15A-15C have become child nodes of the Grok expression graph shown in FIG. 16. Child node 1604 corresponds to the child node 1503 in FIG. 15A and the child node 1508 in FIG. 15B and is connected to nodes 1501 and 1505 located at different levels from the dummy parent node 1602 in the Grok expression graph.

Returning to FIG. 13, in block 1305, a priority, also called a level, is assigned to each node of the Grok expression graph. A priority, or level, is assigned to each node in the Grok expression graph. The dummy parent node is assigned a −1 priority or is located a level −1 of the Grok expression graph) because this node is not actually used to construct Grok expressions as described below. Each child node that descends directly from the dummy parent node is assigned a priority of 0. Priorities (i.e., levels) are assigned to nodes as follows:

priority of child node=priority of preceding child node+1

Nodes with the highest priority are considered first for matching character strings of a log message. Because many nodes located as the same level in the Grok expression graph have the same priority, weights are assigned to distinguish nodes that represent more specific Grok patterns. In block 1306, a weight is also assigned to each node of the Grok expression graph. Nodes with the same priority (i.e., same level) but also have a relatively larger weight are selected for addition to a Grok expression over nodes with the same priority but with corresponding lower weights. Weights are determined by the number of child nodes in each child node's directed acyclic graph as follows:

Node Weight=No. of child node descendants in the child's directed acyclic graph

In FIG. 16, node priorities are identified by numbers in parentheses next to each node. For example, priority 1606 identifies the priority assigned to the dummy parent node 1602. Priority 1608 identifies the priority of the node 1502. A node has only one priority but may have more than one parent node. For example, the node 1604 has two parent nodes and may be assigned the priority of the higher (or lower) of the priorities 1610 and 1612. Priority 1610 follows from the zero priority of zero assigned to node 1501 and priority 1612 follows from the priority of one assigned to node 1505. Node weights, on the other hand, are identified by numbers in brackets next to each node. For example, the weight 1614 of child node 1501 is two because the child node 1501 has two child nodes 1502 and 1604. The weight 1616 of child node 1512 is ten because the child node 1512 has ten child nodes in the directed acyclic graph that descends from the node 1512. Note that leaves, or child nodes located at the ends of paths in the Grok expression graph, have weights of zero.

Returning to FIG. 13, in block 1307, breadth first search traversal is performed on the Grok expression graph in order to arrange nodes at the same depth in decreasing order of the assigned weights.

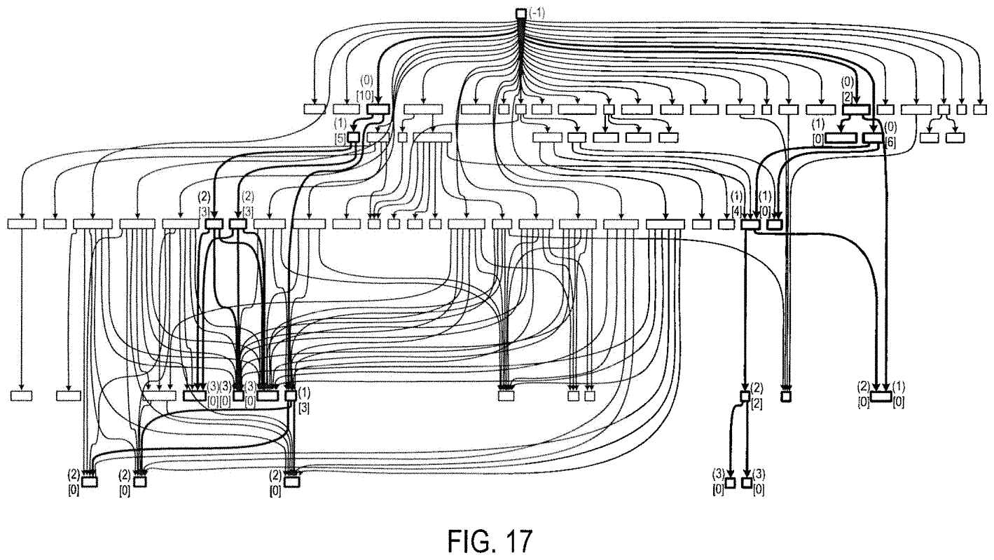

FIG. 17 shows an example of a larger Grok expression graph constructed according the method described above with reference to FIGS. 13-16 from a larger list of default primary and composite Grok patterns. Each node represents a different primary or composite Grok pattern. Bolded edges and bolded nodes correspond to the edges and nodes in the smaller Grok expression graph shown in FIG. 16 with the priorities and weights of the nodes added. The BFS method begins with a selected node, explores the node's child nodes first, then moves to the child nodes of first set of child nodes and so on until the entire graph has been searched.

FIG. 18A shows the Grok expression graph of FIG. 17 partitioned into eleven sections 1801-1811. FIGS. 18B-18L show magnified views of the eleven sections 1801-1811, respectively, to enable reading of the nodes that represent primary and composite Grok patterns and viewing of the directed edges connected to the nodes.

FIGS. 19A-19B show an example of a GUI 1902 that enables a user to select a sample log message to use as a basis for constructing at Grok expression. In FIG. 19A, the GUI 1902 displays on a monitor a portion of the log messages of a stream of log messages received by the log management server. The GUI 1902 includes a scroll bar 1904 that enables a user to scroll through the log messages received by the log management server. Each log message is displayed separately and includes a vertical menu icon (i.e., three vertical dots) that enables a user to select creation of a Grok expression. In the example of FIG. 19A, the user has selected the log message 1906 as a sample log message for a type of log messages that contain desired metric data. In other words, the sample loci message is a sample of a type of log message and is used to construct a Grok expression that parses log messages with the same format as the sample log message. Clicking on vertical menu icon 1908 opens a dropdown menu 1910 shown in FIG. 19B. In this example, the user clicks on the item “Create Metric” to begin the automated process of constructing a Grok expression from the sample log message 1906 as executed by the parser 1212 in FIG. 12.

FIG. 20 shows an example of constructing a Grok expression for the sample log message 1906 using the Grok expression graph in FIGS. 17-18L. Construction of the Grok expression begins by tokenizing the sample log message. Tokens include separate character strings, white spaces, angled brackets, square brackets, curly brackets, commas, semicolons, and colons that are not embedded in character strings. Hyphens, periods, and colons embedded in character strings are not tokenized. For example, a general IP address includes three periods that are separate four numbers. The four numbers and the periods of an IP address are not separate tokens. In this case, the entire IP address is the token. In the example of FIG. 20, a tokenized log message 2000 displays the tokens of the sample log message 1906 with underlining. For example, underline 2002 identifies the entire time stamp of the sample log message 1906 as a single token. Underline 2004 identifies the hostname as a token which comprises character strings separated by hyphens and periods. Underline 2006 identifies a white space token between the time stamp and the hostname. Angled brackets 2008 and 2009, square brackets 2010 and 2011, and curly brackets 2012 and 2013 are identified as separate tokens with separate underlining.

After tokenization, the parser 1212 uses the Grok expression graph to construct a sequence of Grok patterns that correspond to character strings in the sample log message with the same order as the character strings in the sample log message. FIG. 20 shows an example sequence of Grok patterns 2014. The sequence of Grok patterns 2014 comprises Grok patterns, spaces, and brackets that correspond to the order of character strings, white spaces, and brackets in the sample log message 1906. The parser 1212 in FIG. 17 constructs the sequence of Grok patterns from the sequence of tokens in the tokenized log message. The parser 1212 constructs the sequence of Grok patterns by performing the following operations for each level of the Grok expression graph beginning with level 0 and ending with level n:

For each Grok pattern in a current level of the Grok expression graph, the regex of each Grok pattern is compared to each token in the tokenized log message. The parser 1212 determines whether the regex of each Grok pattern matches each token in the tokenized log message. When a regex of Grok pattern matches a token in the tokenized log message, a tracker records the Grok pattern and the location of the token in the tokenized log message. Note that more than one Grok pattern may match a single token of the tokenized log message. For example, FIGS. 18B-18E show nodes that represent Grok patterns located at level 0 in the Grok expression graph shown in FIG. 17. The regex of each Grok pattern represented by a node at level zero is compared to each token in the tokenized log message 1906. For the sake of brevity, consider just two level zero nodes 1812 and 1814 in FIG. 18E, which represent the Grok patterns “DATESTAMP_EVENTLOG” and “TIMESTAMP_ISO8601,” respectively. The regular expressions for these two Grok patterns are compared separately to each of the tokens in the tokenized log message 2000. The regex of the Grok pattern “DATESTAMP_EVENTLOG” does not match any of the tokens in the sample log message 1906. Because the regex of the Grok pattern “TIMESTAMP_ISO8601” matches the token 2002, the tracker records the Grok pattern “TIMESTAMP_ISO8601” in the sequence of Grok patterns 2014 at the same location of the corresponding token in the tokenized log message 2000 as represented by directional arrow 2016.

When regular expressions of two or more Grok patterns in a current level of the Grok expression graph match the same token, the Grok patterns are recorded and the Grok pattern(s) with the highest length are selected by the parser 1212 for addition to the sequence of Grok patterns. The term length refers to the maximum length of a substring matched by the regex in the given input string. Consider, for example, the token “99” in the tokenized log message 2000. None of the level zero Grok patterns oldie Grok expression graph match the character string “99.” At level one, two nodes that represent the Grok pattern “POSINT” in FIG. 18H and the Grok pattern “INT” in FIG. 18L have regular expressions that match the token “99.” These two Grok patterns are stored as representatives of the character string “99.” The parser 1212 then selects the Grok pattern with the longest regex. The regex for the Grok pattern “POSINT” is (?:[1-9][0-9]*) and the regex for the Grok pattern “INT” is (?:[+−]?(?:[0-9]+)). Because the regex for the Grok pattern “INT” has a regex that is able to match longer substrings than the regex for the Grok pattern “POSINT,” the tracker records the Grok pattern “INT” at the location of the corresponding token in the tokenized log message 2000 as represented hr directional arrow 2018.

When two or more Grok patterns in a current level of the Grok expression match the same token of the tokenized log message and have the same length, the tracker compares the weights assigned to the corresponding nodes of the Grok expression graph and records the Grok pattern with the largest associated weight and the location in the sample log messages and discards the other Grok patterns. When two or more Grok patterns also have the same weight, the tracker selects one of the two or more Grok patterns (e.g., at random), discards the other Grok patterns, and records the Grok pattern and the location in the sequence of Grok patterns.

As shown in FIG. 20, tokens that correspond to spaces in the tokenized log message 2000 do not match Grok patterns in the Grok expression graph and are denoted in the sequence of Grok expressions 2014 by the letter “s.” For example, white space token 2006 corresponds to the letter “s” in the sequence of Grok patterns 2000 as indicated by directional arrow 2020. The Various types of brackets and colons that are not embedded in character strings also do match Grok patterns in the Grok expression graph and are added to the sequence of Grok patterns in the same order they appear in the tokenized log message. For example, angled brackets 2008 and 2009, square brackets 2010 and 2011, and curly brackets 2012 and 2013 have been identified as separate tokens that do not match Grok patterns of the Grok expression graph and have been added in the locations in the sequence of Grok patterns 2014.

After the parser 1212 has constructed a sequence of Grok patterns, the Grok expression generator 1214 in FIG. 12 constructs a preliminary Grok expression from the sequence of Grok patterns by placing each Grok pattern into Grok syntax and inserting back slashes “\” before each token space, bracket, semicolon, and colon. For example, FIG. 20 shows a Grok expression 2022 obtained from the sequence of Grok patterns 2014. The Grok expression generator 1214 also adds a hat “\hat{ }” 2024 to the beginning of the Grok expression 2022 and adds a dollar sign “$” 2026 to the end of the Grok expression 2022. The Grok expression generator 1214 constructs a Grok expression from the preliminary Grok expression by inserting default variable identifiers for each Grok pattern of the preliminary Grok expression. FIG. 20 shows an example Grok expression 2028 formed by inserting default variable identifiers for each of the Grok patterns. For example, “int” 2030 is a default variable identifier for the Grok pattern “INT” 2032. Note that subsequent occurrences of the Grok pattern “INT” in the preliminary Grok expression get number default variable identifiers, such as “int_1” “int_2,” “int_3,” and “int_4” in order to distinguish the corresponding variable identifiers. The log intelligence user interface 1202 in FIG. 12 displays the sample log message and the corresponding Grok expression in a GUI.

FIG. 21 shows a GUI 2100 that displays the sample log message 1906 in a sample message field 2102 and the Grok expression in a Grok expression field 2104. The GUI 2100 includes a link RENAME METRICS 2106 that when clicked on displays a GUI 2200 shown in FIG. 22. The GUI 2200 displays a table titled “Rename the metric keys” and comprises three columns. Left-hand column 2202 titled “Suggested Metric Name” displays the default variable identifiers that have been inserted into the Grok expression by the Grok expression generator 1214. Middle column 2204 titled “Metric Value” displays the metrics and character strings of the sample log message 1906 that are currently assigned to the variable identifiers listed in column 2202. Right-hand column 2206 titled “New Metric Value” displays blank entries that may be used to rename the variable identifiers of the Grok expression. For example, a user has entered “response_code” 2208 as the variable identifier used to record response codes embedded in a particular location of the type log message represented by the sample log message 1906. Clicking on the apply button 2208 replaces the default variable identifier “int_3” in the Grok expression 2028 with the user entered “response_code.”

A Grok expression may be used to extract metrics from a type of log message. FIG. 23 shows an example of the Grok expression 2028 used to parse a log message 2302 with the same format as the sample log message 1906. Dashed directional arrows represent parsing the log message 2302 such that character strings that correspond to the Grok patterns of the Grok expression 2028 are assigned to the corresponding variable identifiers. For example, the variable identifier timestamp_iso8601 2304 is assigned the time stamp 2019-07-31T15:21:24.2103 and the variable identifier response_code 2306 is assigned the http status code value 503, which indicates a service is unavailable. The combination time stamp and response code form a time-dependent metric value of a metric that indicates a state of the event source that produced the log message 2302 at a point in time.

FIG. 24 shows an example of a Grok expression 2402 used to parse a log message 2404. Dashed directional arrows represent parsing the log message 2402 such that character strings that correspond to Grok patterns of the Grok expression 2404 are assigned to corresponding variable identifiers. For example, the variable identifier timestamp_iso8601 2406 is assigned the time stamp 2019-07-31T15:21:24.2103, the variable identifier response_code is assigned the value 200, which indicates status is okay, and a variable identifier response_time 2410 is assigned the value 873.522, which is the response time of the event source to a client request at a point in time indicated by the time stamp. The combination time stamp and response code form a time-dependent metric value of a first metric that indicates a state of the event source that produced the log message 2404 at a point in time. The combination time stamp and response time form a time-dependent metric value of a second metric that indicates response time of the event source at a point in time.

FIG. 25 shows a process for extracting metric values from log messages in a stream of log messages 2502. The operations represented by blocks 2504-2507 are repeated for each log message in the stream of log messages and may be performed by the log management server. In block 2504, a log message, such as the log message 2508, is parsed with a Grok expression as described above with reference to FIGS. 23 and 24. In decision block 2505, if the Grok patterns of the Grok expression match the characters strings of the log message 2508, as described above with reference to FIGS. 23 and 24, a time stamp and metric value are extracted and control flows to block 2506. In block 2506, the time stamp and corresponding metric value are recorded to form a sequence of metric values. In block 2507, the process proceeds to the next log message in the stream of log messages 2502.

Each stream of metric data extracted from log messages that match Grok patterns of a Grok expression is a sequence of time-ordered metric values with a corresponding time component that corresponds to the time stamps of the log messages. A stream of metric data is simply called a “metric” and is denoted by

v=(xᵢ)ᵢ₌₁^{N}^{ᵥ}=(x(tᵢ))ᵢ₌₁^{N}^{ᵥ}

where

Nᵥ is the number of metric values in the sequence;

xᵢ=x(tᵢ) is a metric value;

tᵢ is a time stamp of the corresponding log message; and

subscript i is a time stamp index i=1, . . . , Nᵥ.

FIG. 26 shows a plot of an example metric extracted from log messages in a search window. Horizontal axis 2602 represents the duration of the search window. Vertical axis 2604 represents a range of metric value amplitudes. Curve 2606 represents the form of metric values extracted from the log messages as time series data. The metric actually comprises a sequence of discrete metric values in which each metric value is recorded in a data-storage device. FIG. 26 includes a magnified view 2608 of three consecutive metric values represented by points. Each point represents an amplitude of the metric, at a corresponding, time stamp. For example, points 2610-2612 represent three consecutive extracted metric values (i.e., amplitudes) xᵢ₋₁, xᵢ, and xᵢ₊₁ with corresponding time stamps tᵢ₋₁, tᵢ, and tᵢ₊₁. For example, the metric values may represent response times for a server application or HTTP response status codes.

The methods described below with reference to FIGS. 27-28 are stored in one or more data-storage devices as machine-readable instructions that are executed by one or more processors of the computer system shown in FIG. 29.

FIG. 27 shows a flow diagram illustrating an example implementation of a “method for extracting a metric from a stream of log messages.” In block 2701, a sample log message selected by a user using a graphical user interface as described above is tokenized to obtain a tokenized log message as described above with reference to FIG. 20. In block 2702, a “construct a preliminary Grok expression from the tokenized log message” procedure is performed. An example implementation of the “construct a preliminary Grok expression from the tokenized log message” procedure is described below with reference to FIG. 28. In block 2703, a Grok expression is constructed from the preliminary Grok expression obtained in block 2702. In block 2704, the Grok expression is used to extract a metric from log messages with the same format as the sample log message.

FIG. 28 shows a flow diagram illustrating an example implementation of the “construct a Grok expression from the tokenized log message” performed in block 2702 of FIG. 27. A loop beginning with block 2801 repeats the computational operations represented by blocks 2802-2809 for each level of the Grok expression graph. A loop beginning with block 2802 repeats the computation operations represented by blocks for each Grok pattern in the current level of the Grok expression graph. In block 2803, a Grok pattern is compared to each token of the tokenized log message. In decision block 2804, when the regex of the Grok pattern matches the token, control flows to block 2805. In block 2805, the Grok pattern is recorded in a sequence of Grok patterns as the same location of the token in the tokenized log message as described above with reference to FIG. 20. In decision block 2806, blocks 2803-2805 are repeated for another Grok pattern at the same level until all Grok patterns at the level have been compared to the tokens. In decision block 2807, if no Grok patterns match any of the tokens of the tokenized log message, control flow to decision block 2809. Otherwise, control flows to decision block 2808. In decision block 2808, when two or more Grok patterns match the same token, control flows to block 2812. Otherwise control flows to decision block 2809. In decision block 2809, when all levels of the Grok expression graph have been processed, control flows to block 2810. In block 2810, spaces, brackets, semicolons, and colons of the tokenized log message are recorded at corresponding locations in the sequence of Grok patterns as described above with reference to FIG. 20. In block 2811, the sequence of Grok patterns is converted to a preliminary Grok expression as described above with reference to FIG. 20. A loop beginning with block 2812 repeats the computational operations represented by blocks 2813-2819 for each token with two or more matching Grok patterns. In block 2813, Grok patterns of the two or more Grok patterns with the longest regex are identified. In decision block 2814, if only one Grok pattern has the longest regex, control flows to block 2818. Otherwise control flows to decision block 2815. In block 2815, Grok patterns of the two or more Grok patterns with largest weights are identified, In decision block 2816, if only one Grok pattern has the largest weight, control flows to block 2818. Otherwise, control flows to block 2817. In block 2817, a Grok pattern is randomly selected from the two or more Grok patterns. In block 2818, other Grok patterns associate with the token are discarded, leaving the Grok pattern with the longest regex and the largest weight in the sequence of Grok patterns. In block 2819, blocks 2813-2818 are repeated for another token with two or more associated Grok patterns.

FIG. 29 shows an example of a computer system that executes a log management server for generating a Grok expression graph, a Grok expression, and for extracting a metric from a stream of log messages described above. The internal components of many small, mid-sized, and large computer systems as well as specialized processor-based storage systems can be described with respect to this generalized architecture, although each system may feature many additional components, subsystems, and similar, parallel systems with architectures similar to this generalized architecture. Computers that receive, process, and store log messages may be described by the general architectural diagram shown in FIG. 29, tier example. The computer system contains one or multiple central processing units (“CPUs”) 2902-2905, one or more electronic memories 2908 interconnected with the CPUs by a CPU/memory-subsystem bus 2910 or multiple busses, a first bridge 2912 that interconnects the CPU/memory-subsystem bus 2910 with additional busses 2914 and 2916, or other types of high-speed interconnection media, including multiple, high-sped serial interconnects. These busses or serial interconnections, in turn, connect the CPUs and memory with specialized processors, such as a graphics processor 118, and with one or more additional bridges 2920, which are interconnected with high-speed serial links or with multiple controllers 2922-2927, such as controller 2927, that provide access to various different types of crass-storage devices 2928, electronic displays, input devices, and other such components, subcomponents, and computational devices. It should be noted that computer-readable data-storage devices include optical and electromagnetic disks, electronic memories, and other physical data-storage devices.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method stored in one or more data-storage devices and executed using one or ore processors of a computer system for extracting metrics from log messages generated by event sources in a distributed computing system, the method comprising:
providing a graphical user interface (“GUI”) that enables a user to select a sample log message from a stream of log messages;
constructing a Grok expression from character strings of the sample log message; and
using the Grok expression to extract a metric from log messages in the stream of log messages, the log messages having the same format as the sample log message.

2. The method of claim 1 wherein constructing the Grok expression from character strings attic sample log message comprises:
dividing a set of Grok patterns into primary and composite Grok patterns;
constructing relationship graphs for the composite Grok patterns;
forming a Grok expression from the relationship graphs in which relationship graphs descend from a dummy parent node;
assigning a priority to each node of the Grok expression graph, wherein the priority of each node is priority assigned to preceding node plus one;
assigning a weight to each node of the Grok expression graph, wherein the weight of each node is a number of child node descendants in a directed acyclic graph of the child node; and
performing breadth first search traversal of the Grok expression graph to arrange nodes at the same depth in decreasing order of assigned weights.

3. The method of claim 1 wherein constructing the Grok expression from character strings of the sample log message comprises:
tokenizing the sample log message to obtain a tokenized log message;
constricting a preliminary Grok expression from the tokenized log message;
constructing the Grok expression from the preliminary Grok expression; and
displaying the Grok expression in the GUI.

4. The method of claim 1 wherein constructing the Grok expression from character strings of the sample log message comprises:
for each level of a Grok expression graph formed from Grok patterns,
comparing each Grok pattern to a token, and
when a regular expression of a Grok pattern matches character strings of token, recording the Grok pattern in a sequence of Grok patterns that corresponds to the locations of the token in the sample log message; and
recording tokens of the sample log message that correspond spaces, brackets, semicolons, and colons of the sample log message in corresponding locations in the sequence of Grok patterns.

5. The method of claim 1 wherein constructing the Grok expression from character strings of the sample log message comprises:
for each level of a Grok expression graph formed from Grok patterns,
comparing each Grok pattern to a token, and
when a regular expression of a Grok pattern matches character strings of token, recording the Grok pattern in a sequence of Grok patterns that corresponds to the locations of the token in the sample log message; and
when two or more Grok patterns match the same token,
if one of the two or more Grok patterns has a longest regular expression, discarding other Grok patterns that match the same token,
if two or more of the Grok pattern have regular expressions with a same highest length, retaining one of the two or more Grok patterns with a largest weight in the Grok expression graph and discarding other Grok patterns, and
if two or more of the Grok pattern have regular expressions with a same highest length and a same weight, randomly selecting one of the two or more Grok patterns.

6. The method of claim 1 wherein using the Grok expression to extract the metric from log messages in the stream of log messages comprises:
for each log message in the stream of log messages,
parsing the log message with Grok patterns of the Grok expression,
when regular expression of the Grok patterns match character strings of the log message,
assigning character strings to variable identifiers of the Grok patterns,
identifying a variable identifier that corresponds to a time stamp of the log message and a variable identifier that corresponds to a desired metric value recorded in the log message, and
forming a time-dependent metric value from the time stamp and the metric value.

7. A computer system for extracting metrics from log messages generated by event sources in a distributed computing system, the system comprising:
one or more processors;
one or more data-storage devices; and
machine-readable instructions stored in the one or more data-storage devices that when executed using the one or more processors controls the system to performance operations comprising:
providing a graphical user interface (“GUI”) that enables a user to select a sample log message from a stream of log messages;
constructing a Grok expression from character strings of the sample log message; and
using the Grok expression to extract metric from log messages in the stream of log messages, the log messages having the same format as the sample log message.

8. The computer system of claim 7 wherein constructing the Grok expression from character strings of the sample log message comprises:
dividing a set of Grok patterns into primary and composite Grok patterns;
constructing relationship graphs for the composite Grok patterns;
forming a Grok expression from the relationship graphs in which the relationship graphs descend from a dummy parent node;
assigning a priority to each node of the Grok expression graph, wherein the priority of each node is priority assigned to preceding node plus one;
assigning a weight to each node of the Grok expression graph, wherein the weight of each node is a number of child node descendants in a directed acyclic graph of the child node; and
performing breadth first ward traversal of the Grok expression graph to arrange nodes at the sane depth in decreasing order of assigned weights.

9. The computer system of claim 7 wherein constructing the Grok expression from character strings of the sample log message comprises:
tokenizing the sample log message to obtain a tokenized log message;
constructing a preliminary Grok expression from the tokenized log message;
constructing the Grok expression from the preliminary Grok expression; and
displaying the Grok expression in the GUI.

10. The computer system of claim 7 wherein constructing the Grok expression from character strings of the sample log message comprises:
for each level of a Grok expression graph formed from Grok patterns,
comparing each Grok pattern to a token, and
when a regular expression of a Grok pattern matches character strings of token, recording the Grok pattern in a sequence of Grok patterns that corresponds to the locations of the token in the sample log message; and
recording tokens of the sample log message that correspond spaces, brackets, semicolons, and colons of the sample log message in corresponding locations in the sequence of Grok patterns.

11. The computer system of claim 7 wherein constructing the Grok expression from character strings of the sample log message comprises:
for each level of a Grok expression graph formed from Grok patterns,
comparing each Grok pattern to a token, and
when a regular expression of a Grok pattern matches character strings of token, recording the Grok pattern in a sequence of Grok patterns that corresponds to the locations of the token in the sample log message; and
when two or more Grok patterns match the same token,
if one of the two or more Grok patterns has a longest regular expression, discarding other Grok patterns that match the same token,
if two or more of the Grok pattern have regular expressions with a same highest length, retaining one of the two or more Grok patterns with a largest weight in the Grok expression graph and discarding other Grok patterns, and
if two or more of the Grok pattern have regular expressions with a same highest length and a same weight, randomly selecting one of the two or more Grok patterns.

12. The computer system of claim 7 wherein using the Grok expression to extract the metric from log messages in the stream of log messages comprises:
for each log message in the stream of log messages,
parsing the log message with Grok patterns of the Grok expression,
when regular expression of the Grok patterns match character strings of the log message,
assigning character strings to variable identifiers of the Grok patterns,
identifying a variable identifier that corresponds to a time stamp of the log message and a variable identifier that corresponds to a desired metric value recorded in the log message, and
forming a time-dependent metric value from the time stamp and the metric value.

13. A non-transitory computer-readable medium encoded with machine-readable instructions that implement a method carried out by one or more processors of a computer system to perform operations comprising:
providing a graphical user interface (“GUI”) that enables a user to select a sample log message from a stream of log messages;
constructing a Grok expression from character strings of the sample log message; and
using the Grok expression to extract a metric from log messages in the stream of log messages, the log messages having the same format as the sample log message.

14. The medium of claim 13 wherein constructing the Grok expression from character strings of the sample log message comprises:
dividing a set of Grok patterns into primary and composite Grok pattern;
constructing relationship graphs for the composite Grok patterns;
forming a Grok expression from the relationship graphs in which the relationship graphs descend from a dummy parent node;
assigning a priority to each node of the Grok expression graph, wherein the priority of each node is priority assigned to preceding node plus one;
assigning a weight to each node of the Grok expression graph, wherein the weight of each node is a number of child node descendants in a directed acyclic graph of the child node; and
performing breadth first search traversal of the Grok expression graph to arrange nodes at the same depth in decreasing order of assigned weights.

15. The medium of claim 13 wherein constructing the Grok expression from character strings of the sample log message comprises:
tokenizing the sample log message to obtain a tokenized log message;
constructing a preliminary Grok expression from the tokenized log message;
constructing the Grok expression from the preliminary Grok expression; and
displaying the Grok expression in the GUI.

16. The medium of claim 13 wherein constructing the Grok expression from character strings of the sample log message comprises:
for each level of a Grok expression graph formed from Grok patterns,
comparing each Grok pattern to a token, and
when a regular expression of a Grok pattern matches character strings of token, recording the Grok pattern in a sequence of Grok patients that corresponds to the locations of the token in the sample log message; and
recording tokens of the sample log message that correspond spaces, brackets, semicolons, and colons of the sample log message in corresponding locations in the sequence of Grok patterns.

17. The medium of claim 13 wherein constructing the Grok expression from character strings of the sample log message comprises:
for each level of a Grok expression graph formed from Grok patterns,
comparing each Grok pattern to a token, and
when a regular expression of a Grok pattern matches character strings of token, recording the Grok pattern in a sequence of Grok patterns that corresponds to the locations of the token in the sample log message; and
when two or more Grok patterns match the same token,
if one of the two or more Grok patterns has a longest regular expression, discarding other Grok patterns that match the same token,
if two or more of the Grok pattern have regular expressions with a same highest length, retaining one of the two or more Grok patterns with a largest weight in the Grok expression graph and discarding other Grok patterns, and
if two or more of the Grok pattern have regular expressions with a same highest length and a same weight, randomly selecting one of the two or more Grok patterns.

18. The medium of claim 13 wherein using the Grok expression to extract the metric from log messages in the stream of log messages comprises:
for each log message in the stream of log messages,
parsing the log message with Grok patterns of the Grok expression,
when regular expression of the Grok patterns match character strings of the log message,
assigning character strings to variable identifiers of the Grok patterns,
identifying a variable identifier that corresponds to a time stamp of the log message and a variable identifier that corresponds to a desired metric value recorded in the log message, and
forming a time-dependent metric value from the time stamp and be metric value.
